(19) United States
(12) Patent Application Publication
(10) Pub. No.: US 2009/0128335 A1
(43) Pub. Date: May 21, 2009

(54) Wireless Device Tagging System and Method

(75) Inventor: Larry Leung, Santa Clara, CA (US)

Correspondence Address: DLA PIPER LLP (US ), 2000 UNIVERSITY AVENUE, EAST PALO ALTO, CA, 94303-2248, US

(73) Assignee: AIRKAST, INC., San Jose, CA (US)

(21) Appl. No.: 12/209,989

(22) Filed: Sep. 12, 2008

Related U.S. Application Data
(60) Provisional application No. 60/971,866, filed on Sep. 12, 2007.
(60) Provisional application No. 61/034,366, filed on Mar. 6, 2008.

(51) Int. Cl. G08B 13/14; G06Q 30/00

(52) U.S. Cl. 340/572.1; 705/14; 705/26

(57) ABSTRACT

A wireless device tagging system and method are described.

### PRIORITY CLAIMS

This patent application claims the benefit, under 35 USC 119(e) and 120 to U.S. Provisional Patent Application Ser. No. 60/971,866 filed on Sep. 12, 2007 and entitled “Wireless Device Tagging System and Method” and to U.S. Provisional Patent Application Ser. No. 61/034,366 filed on Mar. 6, 2008 and entitled “Wireless Device Tagging System and Method”, both of which are incorporated herein in their entirety.

### FIELD

The system and method relate generally to a system and method for tagging content of wireless devices.

### BACKGROUND

The Internet has transformed how consumers interact and engage with entertainment content from broadcast media such as radio and television. Broadcast media companies have made portions of their content available on the internet to enable consumers to experience and interact with the content through their on-line PCs and extend their reach to new audiences beyond traditional radio and television. Demand from consumers continues to grow for interacting on-line with broadcast media content. For example, growing numbers of on-line radio listeners are interacting with radio station websites to view the playlist of recently broadcasted songs by the radio station to get closer to the music and artists.

Continuing the Internet's extension and integration with mobile devices, the capabilities from on-line PCs and from mobile devices are becoming more homogenous. Mobile devices have become near ubiquitous and technological advancements in devices have provided consumers with richer audio and visual experiences accessing content through the Internet.

It is desirable to provide a system that provides wireless device tagging and other capabilities including provisioning audio, video and graphical images related to content from different types of live broadcast entertainment, such as radio and television. Presently, no solution has been previously identified that allows a wireless device to “tag” content from broadcast media and enables consumers to engage and interact with the content immediately, or at another convenient time. Interaction may include purchasing entertainment or advertised products, sharing product recommendations with friends through their mobile devices or social networks, or simply getting more information on the respective products. Thus, it is to this end that the system and method described below are directed.

### BRIEF DESCRIPTION OF THE DRAWINGS

FIG. 1 illustrates an example of an implementation of a wireless tagging system;

FIG. 2 illustrates a tag and buy example of the wireless tagging system using music using an internet browser enabled wireless device;

FIG. 3 illustrates an example of sponsor messages in the wireless tagging system that uses using an internet browser enabled wireless device;

FIG. 4 illustrates an example of a sponsor tagging method using the wireless tagging system using an internet browser enabled wireless device;

FIG. 5 illustrates an example of a historical graphics wall of the wireless tagging system using an internet browser enabled wireless device;

FIG. 6 illustrates an example of a content voting method of the wireless tagging system using a music example;

FIG. 7 illustrates an example of a synchronization method that may be part of the wireless tagging system that uses an internet browser enabled wireless device;

FIG. 8 illustrates an example of a television broadcast method that may be part of the wireless tagging system that uses an internet browser enabled wireless device;

FIG. 9 illustrates a tag and buy method of the wireless tagging system using a music example;

FIG. 10 illustrates a content voting method of the wireless tagging system using a television broadcast example;

FIG. 11 illustrates another embodiment of the wireless tagging system to access a music tagging application from a wireless device;

FIG. 12 illustrates another embodiment of the wireless tagging system that implements a method for tagging live music using an internet browser enabled wireless device;

FIG. 13 illustrates another embodiment of the wireless tagging system that implements another method for tagging live music using an internet browser enabled wireless device;

FIG. 14 illustrates another embodiment of the wireless tagging system that implements another method for tagging live music using an internet browser enabled wireless device;

FIG. 15 illustrates another embodiment of the wireless tagging system that implements another method for tagging live music using an internet browser enabled wireless device to tag to a music management application;

FIG. 16 illustrates another embodiment of the wireless tagging system that implements a method for purchasing ringtones using an internet browser enabled wireless device;

FIG. 17 illustrates another embodiment of the wireless tagging system that implements a method for tagging live music to generate a playlist using an internet browser enabled wireless device;

FIG. 18 illustrates another embodiment of the wireless tagging system that implements a method for tagging live music to share music using an internet browser enabled wireless device;

FIG. 19 illustrates another embodiment of the wireless tagging system that implements a method for tagging live music using SMS/text;

FIG. 20 illustrates another embodiment of the wireless tagging system that implements another method for tagging live music using SMS/text;

FIG. 21 illustrates another embodiment of the wireless tagging system that implements yet another method for tagging live music using SMS/text and a specific telephone number;

FIG. 22 illustrates another embodiment of the wireless tagging system that implements yet another method for tagging live music using SMS/text and a 800 number;

FIG. 23 illustrates another embodiment of the wireless tagging system that implements a method of a music tagging website using an internet browser enabled wireless device;

FIG. 24 illustrates another embodiment of the wireless tagging system that implements a radio broadcaster configuration tool using an internet browser enabled wireless device;

FIG. 25 illustrates another embodiment of the wireless tagging system that implements a visualization of live radio method using an internet browser enabled wireless device;

FIG. 26 illustrates another embodiment of the wireless tagging system and method;

FIG. 27 illustrate another embodiment of the wireless tagging system and method that implements a method for obtaining wireless device product tagging and search from a website;

FIG. 28 illustrate another embodiment of the wireless tagging system and method that implements another method for obtaining wireless device product tagging and search using pass it on;

FIG. 29 illustrate another embodiment of the wireless tagging system and method;

FIG. 30 illustrate another embodiment of the wireless tagging system and method showing an example of a product tagging/price search website;

FIG. 31 illustrate another embodiment of the wireless tagging system and method showing an example of a product tagging/price search website with price results comparison;

FIG. 32 illustrate another embodiment of the wireless tagging system and method showing an example of a product tagging/price search website with local store highlights and inventory check; and

FIG. 33 illustrate another embodiment of the wireless tagging system and method showing an example of a product tagging/price search website with a watch it feature.

### DETAILED DESCRIPTION OF ONE OR MORE EMBODIMENTS

The system and method are particularly applicable to a mobile network, web based system that has a website and one or more internet browser enabled wireless device such as a mobile phone as shown in the diagrams below and it is in this context that the system and method will be described. It will be appreciated, however, that the system and method has greater utility since the system may be implemented using various different links, such as computer networks, mobile networks, cellular networks and/or other links, may be implemented using other implementations for the tagging unit and may be implemented using various wireless devices which may include a processing unit based device with sufficient processing power, sufficient memory, display capabilities and connectivity such as for example a mobile phone as shown below, a phone capable device such as Blackberry, Palm Treo and the like, a laptop computer, a desktop computer, or any other devices that are capable of interacting with tagging unit as described below. One example of an implementation of the wireless tagging system and method is the AirKast system and method described below.

The system and method provide the capability for wireless device users to “tag” products, services and various forms of broadcasted entertainment. In essence, tagging is defined as the ability for a user to use the human senses of touch, sight or hearing to come into contact with a product, service or some form of entertainment, and use a wireless device to initiate various wireless and internet transactions. Wireless devices give users the portability and convenience to initiate some desired online transaction immediately, and then be able to complete the desired online transaction at a deferred time when it is more convenient to do so.

The system and method are comprised of custom developed software and algorithms for wireless devices, computing devices and file servers. A wireless device is defined as a device that may be as basic as a voice only cell phone, a cell phone with screen display and SMS text message capability or as sophisticated as wireless PDAs (Personal Digital Assistant) and Smart Phone devices with internet browser capability. Each wireless device may have a tag module and a purchase module (implemented in software in one embodiment) that allow the wireless device to tag an item (such as a product or service as described below in more detail) and to purchase the tagged item directly from the wireless device. Computing device is defined as a device that is used to access the internet and run web based applications. File servers are defined as servers in the client/server two-tier software architectural model that collects and processes instructions, and sends back results both from and to wireless and computing devices. The servers also collects, processes and stores information from the internet and other servers, in addition to storing data and applications relating to the system and method. An online transaction refers to numerous categories of transactions conducted over the internet which broadly includes purchasing products, services and forms of entertainment from online merchants, general e-Commerce capabilities and interaction with other users (both through their wireless device and online computing device) and social networking websites.

The system may permit the owner of the system to generate revenue from a whole host of advertising strategies targeting wireless devices and internet web based campaigns, banner ads, “click-through” advertising, commissions and incentives from the lead generation, referral and sales of products, services or various forms of entertainment. Advertising strategies and pricing structures for the two separate mediums (wireless device and computing device) may be developed as a coordinated and complimentary advertising ecosystem, or as independent mediums for those advertisers that want to only target users in the selected medium.

An example of a tagging system relates to a user being able to tag a form of broadcast entertainment. Radio stations, in this example, typically broadcasts music over the air waves. While listeners enjoy hearing the music, they typically are not able to remember the name of the song and the artist after it is broadcasted on the radio station. There has been no method for listeners to hear a song on the radio and be able to immediately create an easy reference at a later period of time to purchase the song from an online music provider. With participating radio stations implementing the system and method, listeners with a wireless device can listen to a song broadcasted live on the radio and use their wireless device to immediately see the corresponding title of the song and the artist and be able to tag the song for later reference through their computing device. Capabilities exist through the wireless device to view the lyrics to the song as well as sharing the name and artist of the song with friends and family members.

Once the song has been tagged by the wireless device, the system provides through the listener's computing device methods to conduct a number of online music purchase transactions and enable the listener to share the tagged song with friends and family that participate in social networking sites.

Another example of a tagging system relates to a user being able to tag a consumer product at a retail store. Currently, price comparison shopping is frequently done when shoppers have a product code or a product description and complete their research through a computing device at home. The system and method would give a shopper true portability and convenience by enabling him/her to tag a product through a UPC or ISBN code from a product they physically see at a store and then have price comparison information sent back to his/her wireless device momentarily. This provides invaluable price knowledge information anytime and almost anywhere, enabling the shopper to make an informed decision whether to complete the purchase of the tagged product at a brick and mortar store they're physically shopping at now. If the shopper, based on the price knowledge information received from the wireless device chooses to realize significant savings by completing the purchase of the tagged product at a later time through a computing device, the system and method has created a number of methods to review merchants offering the product at the lowest prices. Capabilities exist to also perform location based inventory searches, even though they may not offer the products at the lowest prices, and reverse auction like bidding processes for tagged products.

In a final example, the system and method supports the ability for a wine enthusiast to use a wireless device to tag a bottle of wine he/she is enjoying at a restaurant, is considering buying while shopping at a wine retailer, or spontaneously hears a recommendation from a friend or family member. The system and method requires the vineyard and vintage information for the interested wine to be entered onto the wireless device. The wine enthusiast will then be able to obtain through the wireless device price/availability information about the interested wine. Depending on the circumstances, the wine enthusiast can decide whether to complete the purchase where he/she is at, or alternatively, tag the interested wine for later consideration and purchase online through a number of national online wine retailers. Now, further details of each of these examples are provided.

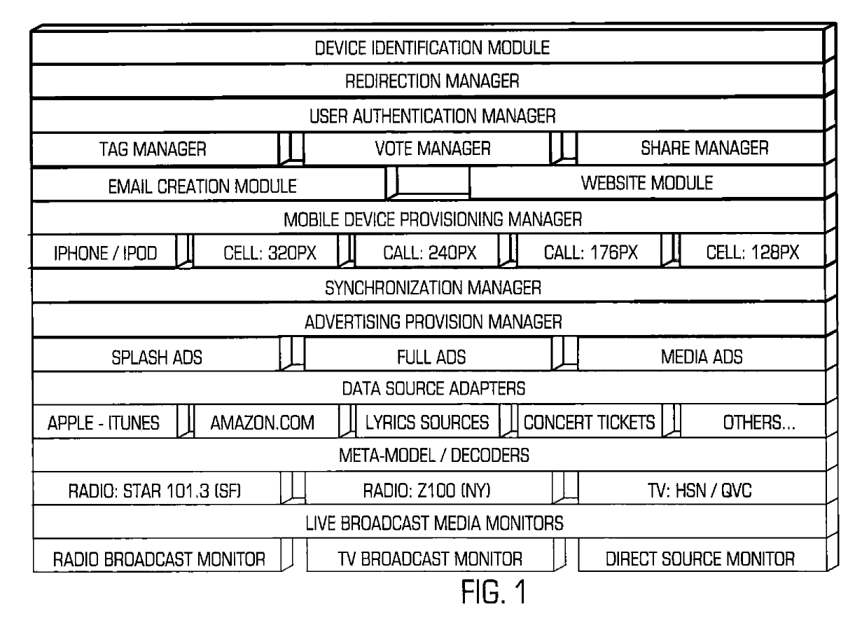

FIG. 1 illustrates an example of an implementation of a wireless tagging system. As shown, the wireless device tagging system and method (also termed a “platform”) comprises multiple layers of devices/units/modules (that may be implemented in software) which permits the system to:
Monitor and track live real-time media broadcast, which includes (but not limited to) radio and television transmissions in any format including analog and digital.
Perform real-time contextual searches on content making up the live media transmission.
Present and transmit to wireless devices value added information and content in both (or either) textual and graphical format pertaining to the live broadcast during the real-time transmission of the entertainment.
Enables end users to interact with the presented content on their wireless devices which includes (but not limited to) tagging/book-marking of the presented content, voting, browsing previously presented content and sharing of tagged content amongst other users of the system or users belonging to networks and common interest groups such as social networks sites
Enable end users to view all tagged content on web enabled computing devices with additional rich value added information pertaining to the tagged content.
Enable end users to initiate and complete a purchasing transaction of the tagged content or additional value information linked to the tagged content. For example, a song, album or concert tickets.
Enable advertisers to present relevant product or service information delivered by the AirKast Wireless Tagging System to the wireless devices simultaneously or in scheduled intervals with the content and advertiser messages pertaining to the live broadcast.

In particular, as shown in FIG. 1, the system (a computer implemented tagging unit) may include a device identification module (that identifies each device that connects to the wireless tagging system including the attributes of the device such as screen size and resolution, data speed and the like) and a redirection manager that, based on the request for each device, redirects the device to the appropriate location and link and a user authentication manager that authenticates each user and each wireless device that interacts with the wireless device tagging system. The system may also include a tag manager (that manages the wireless device tags in the system), a vote manager that manages the votes of the users of the wireless devices and a share manager to managing the sharing of content among the wireless devices. The system may also have a mobile device provisioning manager for different wireless/mobile devices, a synchronization manager that manages the synchronization process and method as described below in more detail, and an advertising provision manager (that manages splash ads, full ads and media ads, that are delivered to the wireless devices (as described below in more detail). The system may also include data source adapters (that accept data from different sources and makes the data available to the system), meta-model decoders (that decode television and radio sources) and live broadcast media monitors that monitor radio, television and direct sources of information. These modules and managers may be implemented in software running on one or more server computers that include, when the web-based implementation is done, a web server, etc that allows the devices to connect to and communicate with the wireless tagging system.

In addition to the systems and methods described above, the wireless tagging system and method may include the following additional functionality.

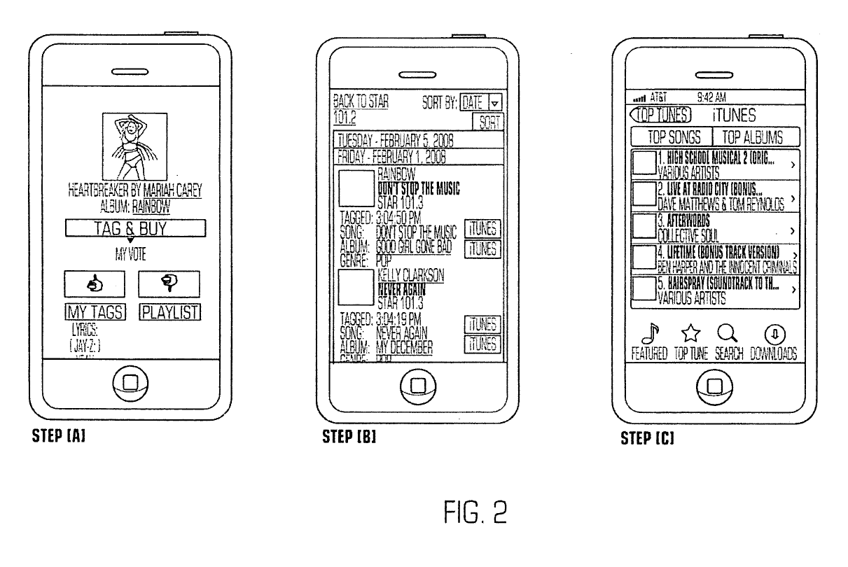

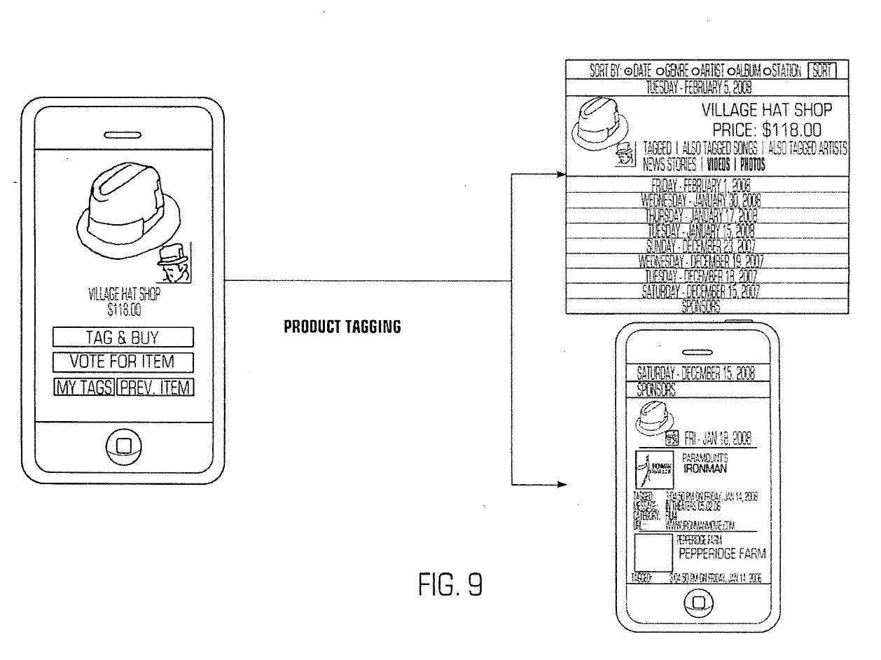

1. Tag and Buy—See FIGS. 2 and 9

As described above, the Wireless Device Tagging System monitors and retrieves in real-time information in relation to live media broadcast. Users can tag items of interest and complete a purchase transaction (later) on their web enabled computing device.

As illustrated in the reference document, this extension outlines methods enabling the AirKast Wireless Device Tagging System to permit users to additionally view and complete a purchase transaction on their wireless device. Items such as music will subsequently be downloaded straight to the wireless device.

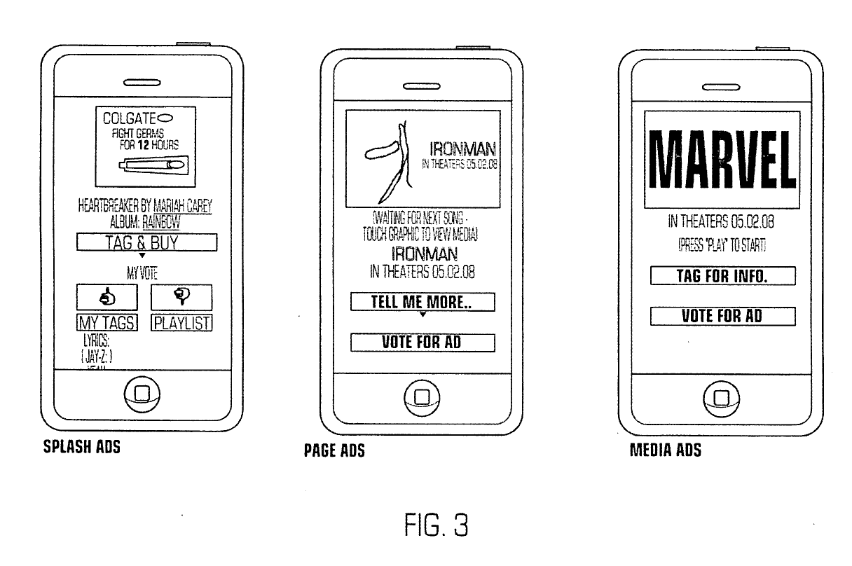

2. Splash Ads, Page Ads and Media Ads—See FIG. 3

The reference illustration presents usage terms and show provisioning algorithms and techniques used to present advertising messages to wireless devices. The AirKast Wireless Device Tagging System has been extended to provision three distinct and unique types of advertising messages integrated into the content provisioned during broadcast of live media or during the commercial presentation portions of the live media broadcast.

The three types of AirKast advertising messages are:

Splash Ads: Advertiser messages are integrated and rotated in sequence on the wireless device's display along with graphic content related to the live media broadcast e.g. album cover art of the current playing song.

Page Ads: Advertisers messages are full screen and presented during the transmission of commercial messages by the live media broadcast companies. The advertising messages are in sync with current playing commercials transmitted by the live media broadcast companies.

For example, a radio station broadcasts information regarding the up coming release of a movie. The AirKast Wireless Device Tagging System will present graphical and value-added content to wireless devices in regards to the movie release.

Media Ads: Along with the presentation of AirKast's Page Ads, video enabled wireless devices will also be presented with full video and audio presentations of any given advertiser's messages that can be viewed immediately on the user's wireless device.

For example, a radio station broadcasts information regarding the up coming release of a movie. The AirKast Wireless Device Tagging System will present graphical and value-added content to wireless devices in regards to movie release in the format of an AirKast Page. Ad. For video enabled wireless devices, selecting/clicking/touching on the Page Ad will present the user with a full video and audio presentation of the advertiser's message i.e. a movie trailer.

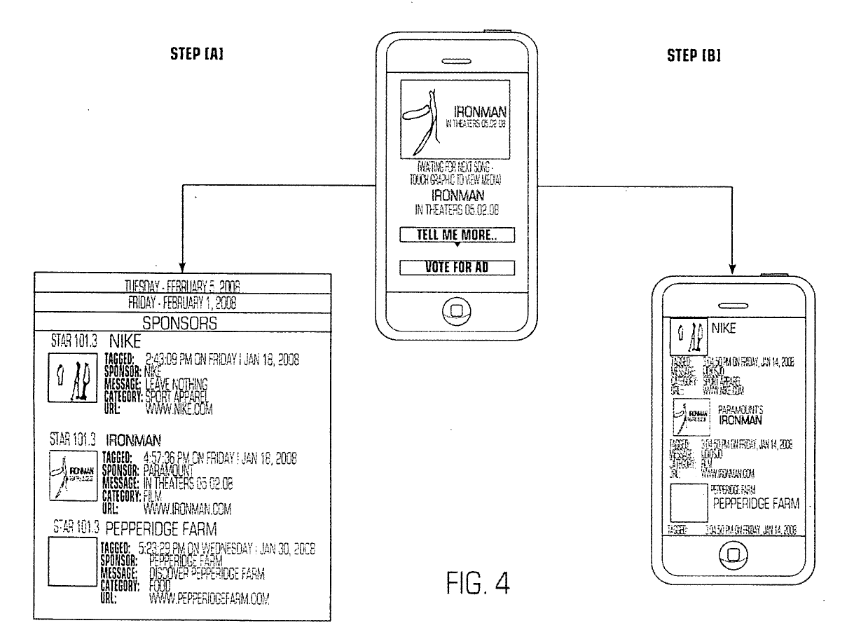

3. Sponsor/Advertising Tagging—See FIG. 4

In addition to permitting users to tag items of interest during live media broadcast, the AirKast Wireless Device Tagging System has been extended to encompass techniques and methods permitting users to tag advertising messages delivered to their wireless device. Additional information regarding the tagged advertising message will be provisioned into the user's account and can be viewed using a web enabled computing device or via their wireless device.

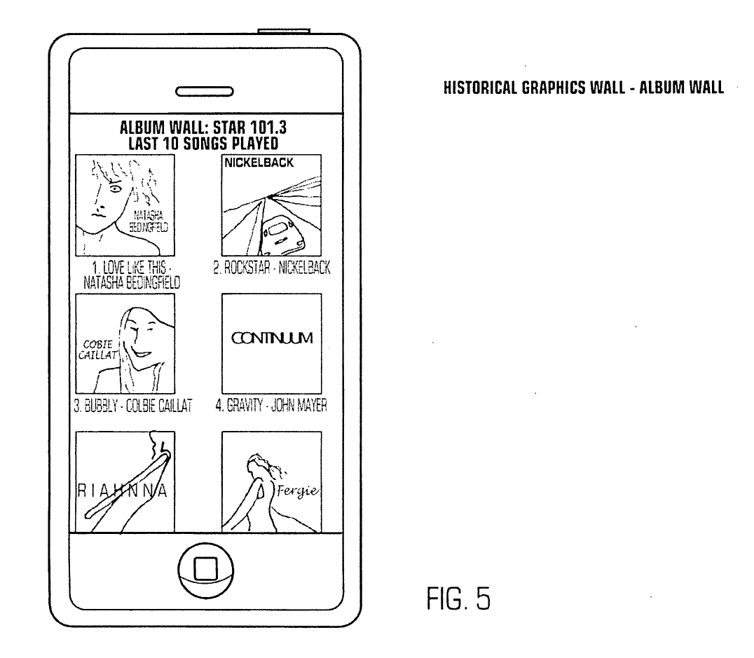

4. Historical Interactive Graphics Wall—See FIG. 5

The referenced illustration presents an extension to the AirKast Wireless Device Tagging System that enables users to view previously provisioned items (e.g. songs, consumer products) via an interactive graphical presentation. Selecting/clicking or touching on any presented graphical presentation permits the user to drill down for more information in regards to the listed item and complete a purchase transaction on their wireless device.

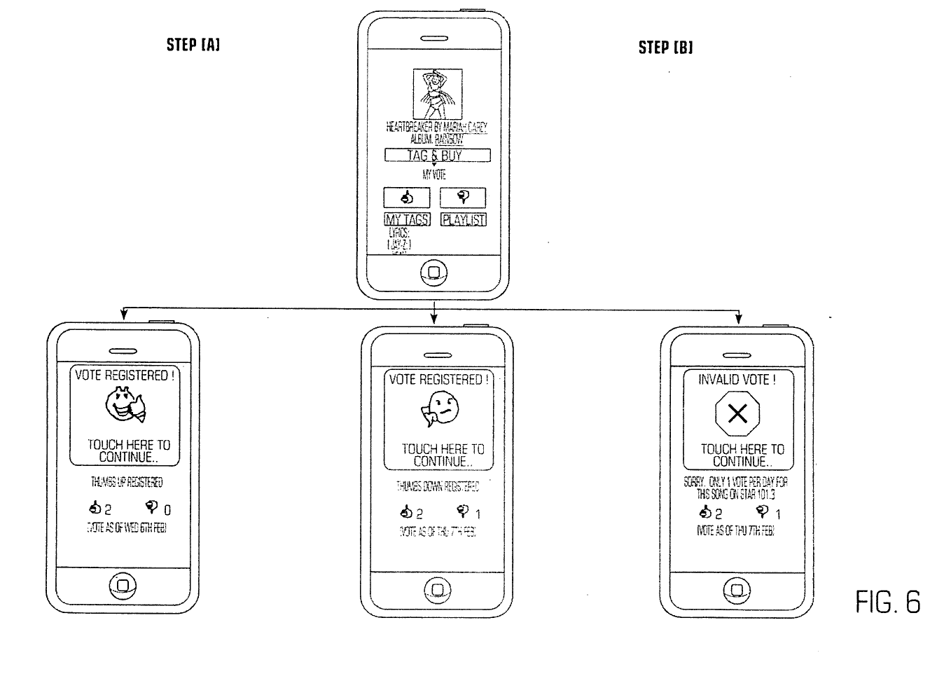

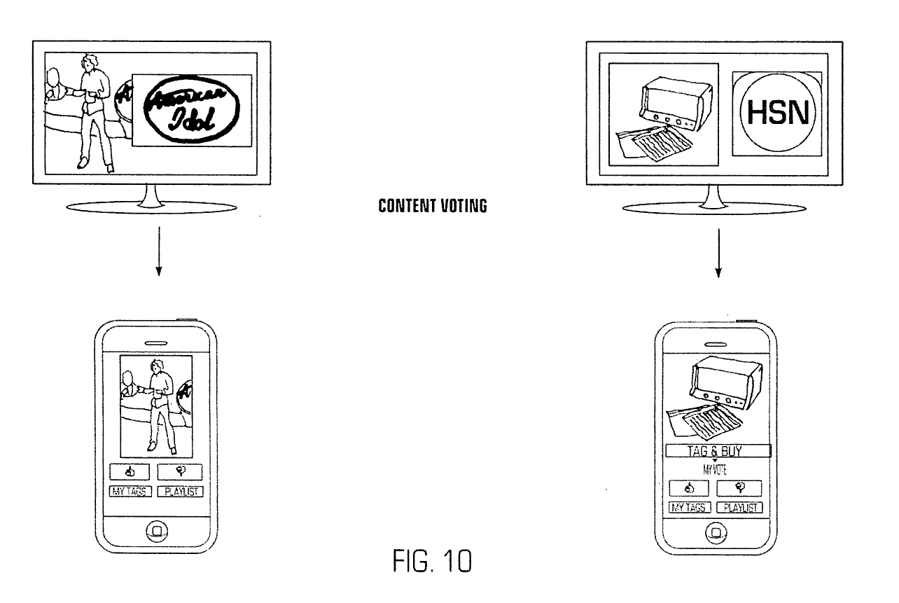

5. Content Voting Usage and Implementations—See FIGS. 6 and 10

The above illustration presents new additions, usages and extensions to the AirKast Wireless Device Tagging System voting technology.

The AirKast Wireless Device Tagging System voting technology enable users to vote on live broadcasted media content which are represented on their wireless device via the AirKast Wireless Device Tagging System.

The AirKast Wireless Device Tagging System's voting technology incorporates a unique configurable rules based engine, which determines the voting rules for each presented item for voting users. For example, users can vote twice a week for each particular song played on a particular radio station's live broadcast. Or vote once for each contestant on a live television broadcasted show.

Current counted votes are presented to the voting users after their votes.

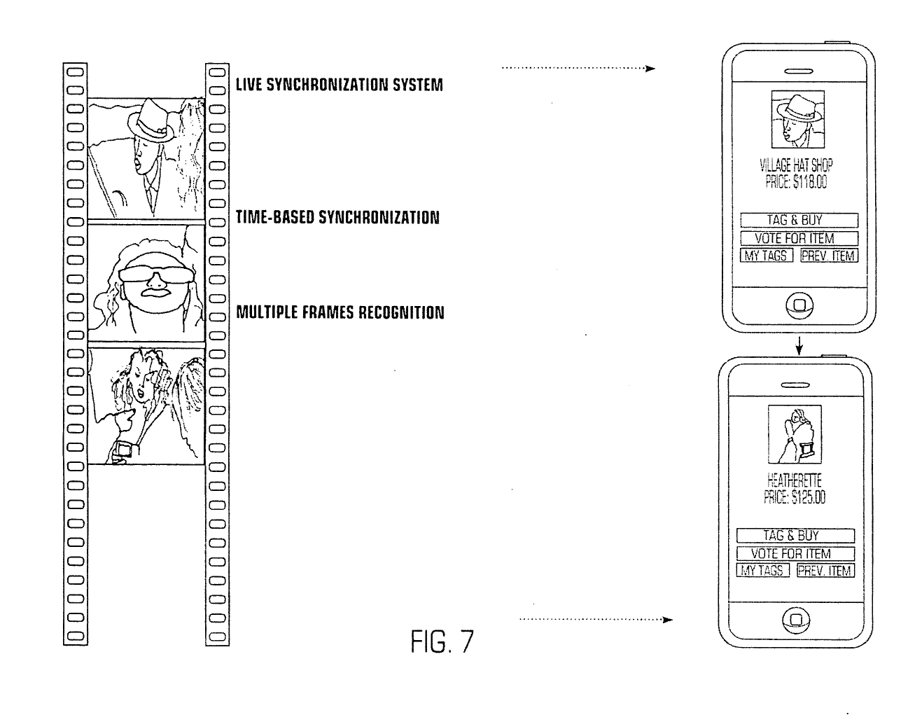

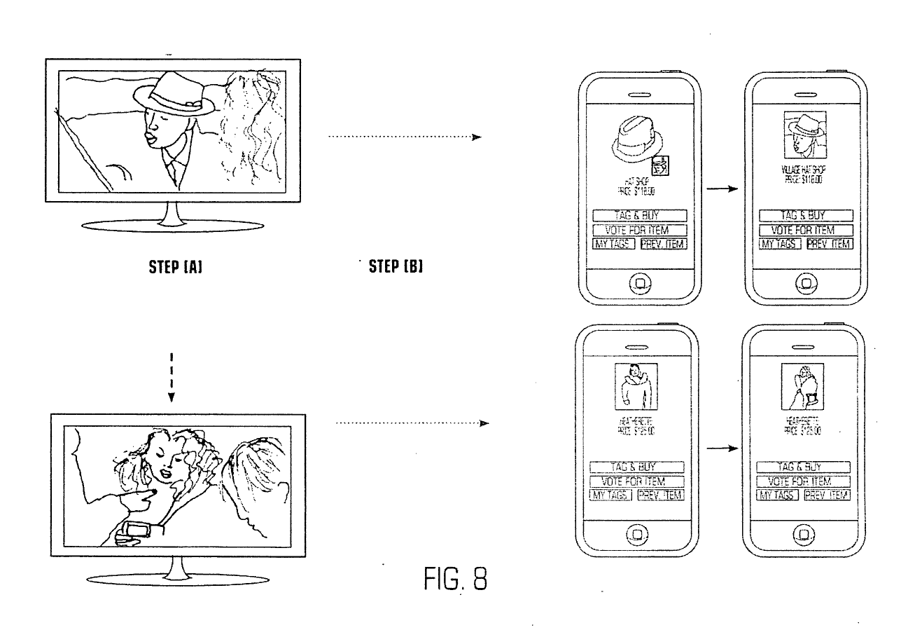

6. The AirKast Wireless Tagging System's Real-time Synchronization Technology for Live Broadcast Media—See FIGS. 7-10

As described above, the Wireless Device Tagging System monitors and synchronizes content presented to wireless devices that is being transmitted in real-time via broadcast media companies.

As illustrated in the reference document, this extension outlines algorithms and techniques that enable the AirKast Wireless Device Tagging System to use time-based, and multiple frames recognition meta-models and algorithms to synchronize content presented to wireless devices during the live media broadcast. The AirKast Wireless Device Tagging System's unique synchronization method enables a concept called “multiple entry point synchronization”—synchronizing mobile devices to the broadcast content any time users joins the live media broadcast.

7. Additional Applications of the AirKast Wireless Tagging System—See FIG. 7-10

The above illustrations referenced describe a new and unique application of the AirKast Wireless Tagging System—to monitor and retrieve in real-time or in scheduled intervals contextual information in relation to live television broadcast.

The illustrations show the application of the AirKast's Wireless Tagging and System's unique algorithms and methods to presents to wireless devices value-added information, the ability to tag for reference, tag and buy and vote on products and content transmitted during live broadcast to conventional television devices.

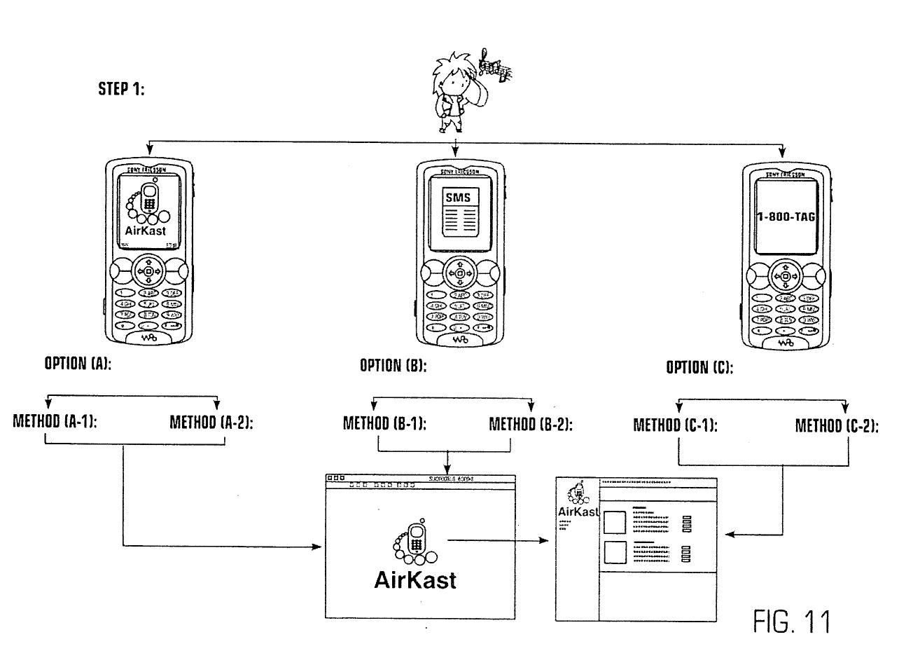

FIG. 11 illustrates another embodiment of the wireless tagging system to access a music tagging application from a wireless device. Listeners enjoy music in their car, office, home or wherever a radio can receive radio broadcasted over the air waves. While listeners enjoy hearing the songs, they typically are not able to remember the name of the song, the artist or have a convenient way to view the song lyrics to the songs being broadcasted. The invention consists of custom developed software and algorithms for wireless devices, computer devices and file servers to allow listeners from participating radio stations listeners with an appropriately featured wireless device to tag songs and view song lyrics as they are being broadcasted. The invention also provides methods for listeners to conduct a number of online transactions such as purchasing the tagged song, the music album the song was played from, other albums and music videos from the same artist.

The system enables listeners to have the ability to purchase the ringtone through an online music or ringtone provider from their wireless device. If listeners have friends and family members they would like to share the song title, name of the artist and lyrics of the song with, the invention provides sharing capability through the wireless device. The friends and family members in turn can also tag those songs to purchase online the particular song, music album the song was played from, other albums and music videos from the same artist. Through the listener's computing device, he/she accesses his/her web account through the company's designated website and share tagged songs with friends and family members that have accounts with social networking sites such as MySpace and Facebook by selecting automated posting processes.

Targeted advertisements can be displayed on listeners' wireless device display screen in conjunction with the tagged songs and displayed lyrics. Each radio station has the ability to tailor advertisements based on date/time criteria and numerous types of visual advertisements that offer variable degrees of advertiser interaction with listeners' through their wireless devices. The invention allows for advertising strategies to be developed and implemented either as individual mediums, or dual coordinated mediums for both wireless device and computing device advertising mediums simultaneous or near simultaneous as songs are broadcasted from the radio station.

During traditional broadcast of radio audio advertisements, the innovation also allows for the simultaneous or near simultaneous display of visual advertisements onto user's wireless devices. To supplement the effectiveness and recall rate of broadcast radio audio advertisements, visual advertisements on the wireless device can be displayed in a wide range of graphical, pictorial, text and other visual formats, all available with variable degrees of advertiser interaction with listeners. What distinguishes this innovation from other stand alone advertising mediums (e.g. advertisements published on wireless devices) is the publishing of advertisements on wireless devices simultaneous or near simultaneous with live broadcasting of radio audio advertisements. The applications and processes that form the visual advertisements on wireless devices during the broadcasting on songs, and during the simultaneous or near simultaneous broadcasting of radio audio advertisements are collectively recognized as “the visualization of radio”.

Revenue for AirKast will be generated from banner ads, “click-through” advertising (HTML links that can direct users to advertisers' websites), other forms of visual advertisements, a whole host of wireless and computing device based advertising strategies (either as single mediums or coordinated dual medium strategies) that are implemented both during broadcasting of songs and during the simultaneous or near simultaneous broadcasting of radio audio advertisements. In addition, revenue will be earned through commissions and incentives from the sale of songs, albums, music videos, ringtones, artist concert tickets and other e-commerce activities available from online providers of broadcast and music entertainment. Different advertising strategies and pricing structures may be developed for the two separate mediums, wireless and computer device, given their respective screen size and level of transaction sophistication with tagged music each medium can support.

Radio Station Music Information Transmission to AirKast

There are (3) methods for AirKast to receive information from the radio station (which may be FM, AM, Satellite or Television frequencies) during live broadcasting in order for the AirKast servers to generate the corresponding song information for tagging and viewing of lyrics on a wireless device:

Method (1) AirKast places a RDBS tuner and server in the local geography locked onto the radio station that listeners want to tag music and view lyrics from; the song and artist information broadcasted from the radio station is then sent over the internet to the AirKast servers which retrieves and publishes the specific song information for tagging and viewing of lyrics on listeners' wireless devices

Method (2) AirKast captures and retrieves the song and artist information being played on the radio station directly from their website or deciphering the metadata stored in the audo stream; the AirKast servers then retrieves and publishes the specific song information for tagging and viewing of lyrics listeners' wireless devices

Method (3) AirKast creates a web-based application for radio stations to run on their broadcast systems and sends the song and artist information to the AirKast servers, which then retrieves and publishes the specific song information for tagging and viewing of lyrics on wireless devices

Accessing the Music Tagging Application from a Wireless Device

There are (3) methods for listeners to access the music tagging application from their wireless device (as shown in FIG. 11)

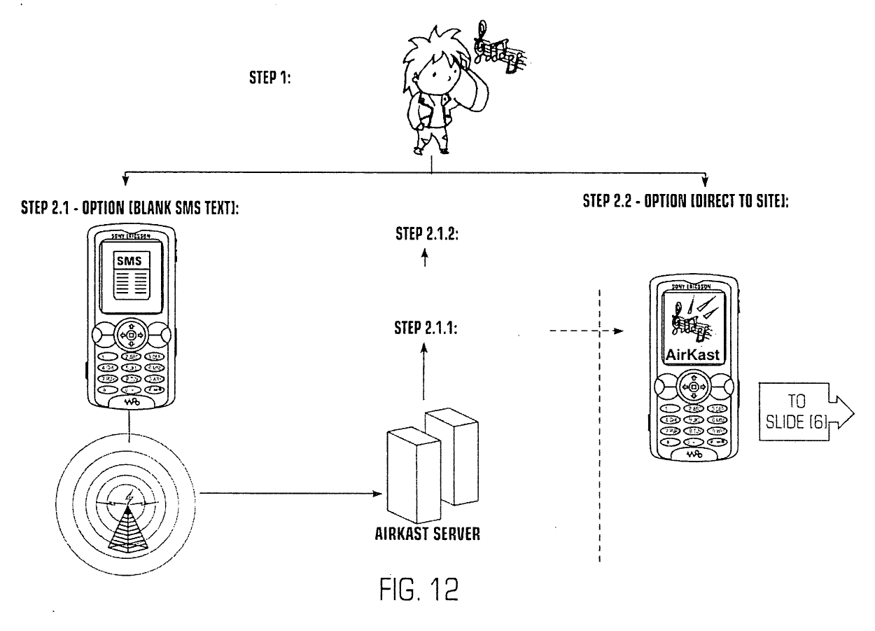

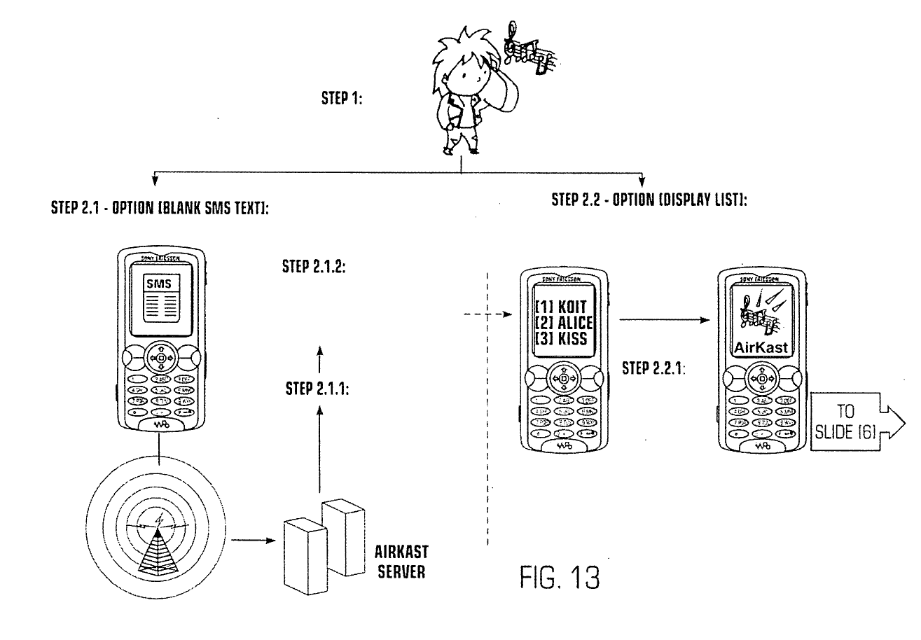

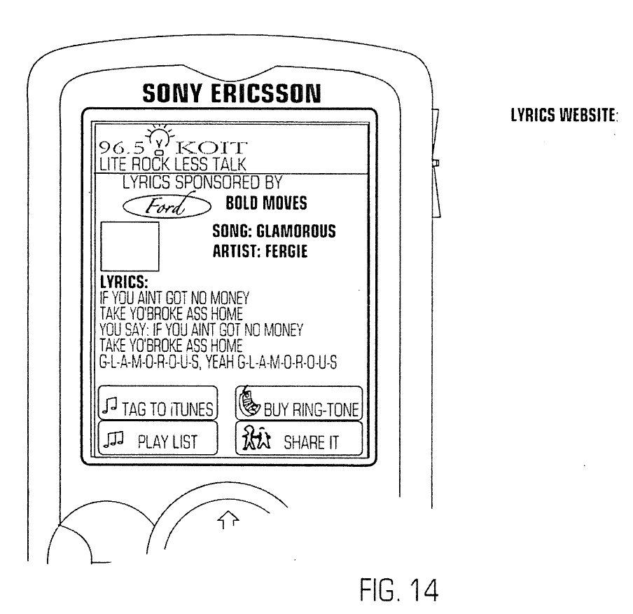

1. Method (A): Internet browser enabled wireless device
user listens to a broadcasted song on the radio and desires to tag the song and view the song's lyrics
user is made aware of the unique URL designated for the specific radio station through the radio station's live programming, the radio station's website, the AirKast designated website or requests the specific radio station's URL by sending either a blank or pre-published code of character(s) in a SMS text message to the radio station's SMS number (or short code designated by AirKast) (see FIG. 12)
if user sends a SMS text message to the radio station's SMS number (or short code designated by AirKast) requesting the URL, the SMS text message is sent via the user's mobile network provider to the AirKast server, where the request is processed and sends back the link to the specific radio station to the user (see FIG. 12, steps 2.1-2.1.1))
alternatively, a user sends to a blank message or some other pre-published code of character(s) to a short code designated by AirKast; the AirKast server then sends back to the user via SMS text messaging a link of a list of radio stations being monitored in the local area based on the user's wireless device area code (see FIG. 13)
user then selects the participating radio station he/she desires to listen to and have the ability to tag music and view song lyrics being broadcasted (see FIG. 13, step 2.2.1))
through methods (A-1) and (A-2) (shown in FIGS. 12 and 13, respectively), user will be able to tag music and view lyrics to songs currently being broadcasted from radio stations he/she is monitoring from their internet browser enabled wireless device; in addition, user is able purchase ringtones of the song, view previously broadcasted songs, create a playlist of tagged songs and lyrics with friends and family by sharing those songs with them, and be able to view advertising and sponsor messages between music broadcasts (see FIG. 14).

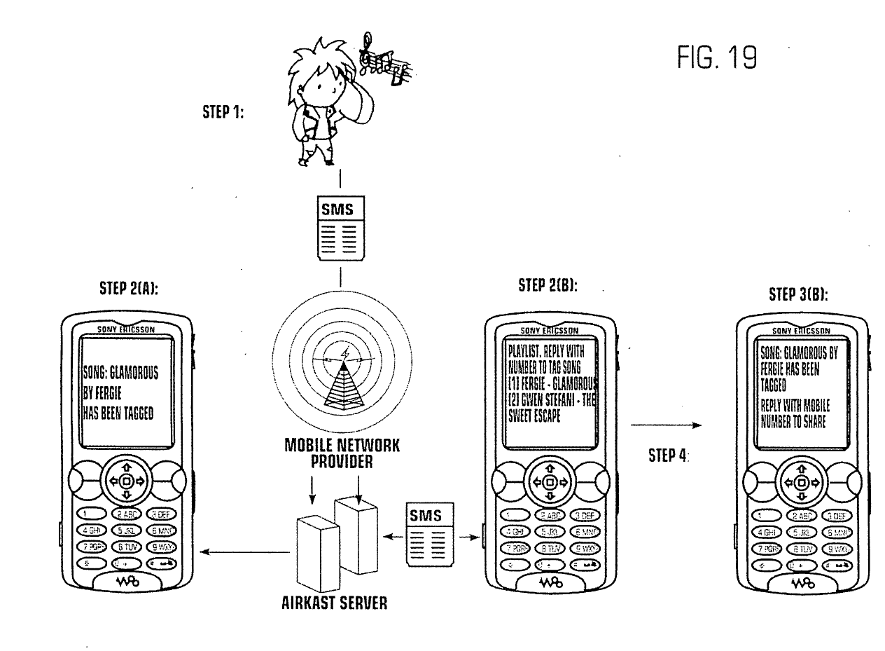

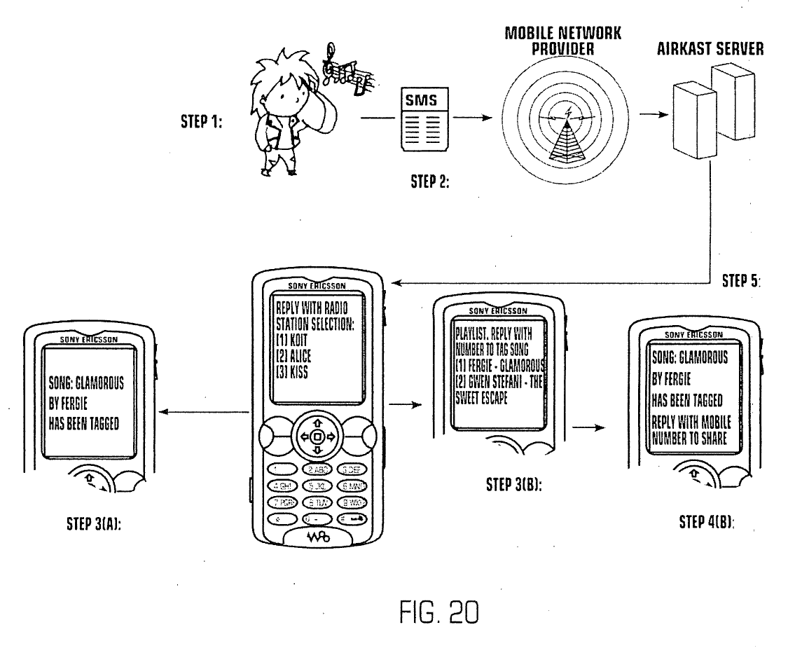

2. Method (B): SMS Text Message
user listens to a broadcasted song on the radio and desires to tag the song to enable him/her to conduct a number of music purchase transactions at a later time
user is made aware of the participating radio station's SMS number (or short code designated by AirKast) through the radio station's live programming, the radio station's website and the AirKast designated website
user enters a participating radio station's SMS number (or designated AirKast short code), the blank SMS text message is sent via the user's mobile network provider and processed by the AirKast server, the currently broadcasted song from the particular radio station is tagged and confirmation of tagging is sent to the user (see FIG. 19, steps 1-2(A))
alternatively, for users that access the music tagging application through a short code designated by AirKast, the AirKast server recognizes the area code the user originating the SMS text message was sent from.
the AirKast server then sends back via the user's wireless carrier a SMS text message with a list of participating radio stations that have installed and deployed the AirKast music tagging application within the local geography of the user's wireless device area code (see FIG. 20, step 2)
user selects the participating radio station he/she chooses to tag music from and is able to tag songs as they are broadcasted (see FIG. 20, step 2)
once the user tags the song desired, a confirmation is sent back to the user through SMS text message (see FIG. 20m step 3(A))

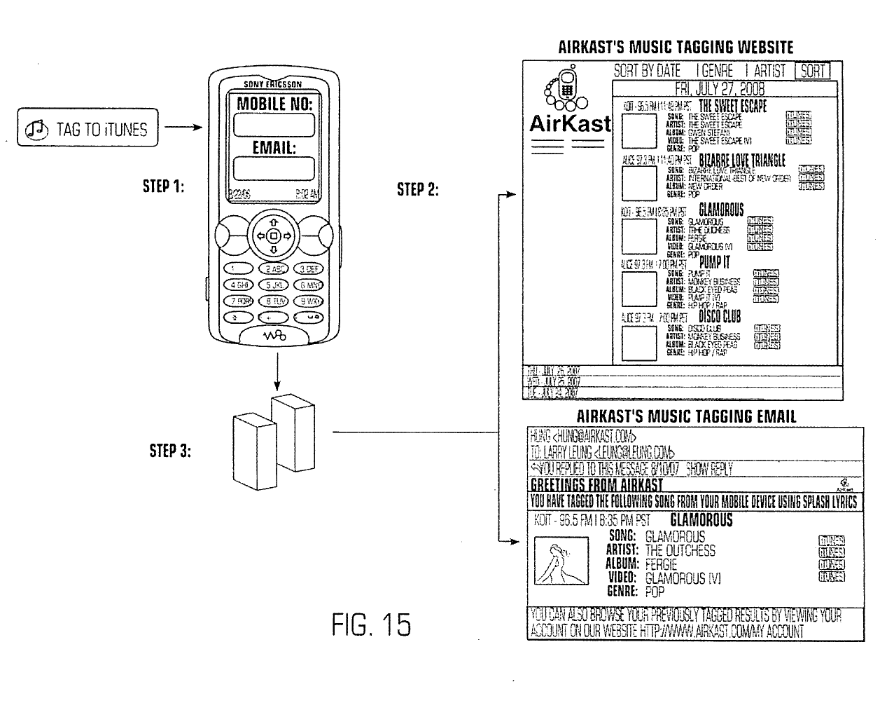

3. Method (C): Interactive Voice Response System (IVR System)
user calls from their wireless device a designated telephone number into an IVR System and follows voice prompts that allows him/her to tag music website (see FIG. 11, method (C)) Music Tagging via an Internet Browser Enabled Wireless Device
user is connected to the designated URL and viewing lyrics from the selected radio station from his/her internet browser enabled wireless device
user selects the “Tag” feature for the currently displayed song from the screen menu, enters his/her wireless device phone number and email address or some other identity authentication process (see FIG. 15, step 1)
when the identity authentication information is entered for the first time on the wireless device, it will not require repeated authentication entries when the user desires to launch again the “Tag” feature due to the application's cookies being installed onto the wireless device during the initial identity authentication process (see FIG. 15, step 2)
the AirKast server processes the request to tag the currently displayed song, and the following information is generated by the AirKast server into the user's web account: details of the tagged song such as song title, artist, album song was from, other albums and music from the artist, album cover art work, artist bio, and artist concert information including registering for email alerts to notify users when event tickets go on sale (see FIG. 15, step 3)
once the tagging process is completed by the AirKast server, a confirmation is sent through the user's email account and wireless device noting the selected song/artist was successfully tagged

Music Tagging via SMS Text Messaging

Method (B-1) SMS Text Messaging to a Radio Station's SMS Number
user listens to a broadcasted song on the radio and desires to tag the song for later purchase; he/she sends to the radio station's SMS number (or a short code designated by AirKast) a blank SMS text message or a code of pre-published character(s) to initiate the tagging process (see FIG. 19, step 1)
the AirKast server receives the request, recognizes the radio station to tag music from, based on the published radio station's short code or designated AirKast short code the SMS text message was sent to and tags the current broadcasted song
once the request to tag the song has been processed by the AirKast server, a return SMS text message confirmation is sent to the user indicating the selected song/artist was successfully tagged (see FIG. 19, step 2(A))
alternatively, the user can send a blank SMS text message to the published radio station's short code which the AirKast server receives and recognizes the short code to monitor the desired radio station; a SMS text message is then sent back to the user with the list of the last 3-10 songs broadcasted by the radio station; user selects which song he/she would like to tag and the instruction is sent to the AirKast server via SMS text message; confirmation is then sent back to the user via SMS text message song was successfully tagged (see FIG. 19, step 2(B))
user selects which song he/she would like to tag and the instruction is sent via SMS text message and processed by the AirKast server
when the instruction from the wireless device to tag a song is received by the AirKast server, the following information is generated by the AirKast server into the user's web account: details of the tagged song such as song title, artist, album song was from, other albums and music from the artist, album cover art work, artist bio, and artist concert information including registering for email alerts to notify users when event tickets go on sale.

Method (B-2) SMS Text Messaging to AirKast Server
user listens to a broadcasted song on the radio and desires to tag the song for later purchase; he/she sends to an AirKast designated short code a blank SMS text message or a code of pre-published character(s) to initiate the tagging process (see FIG. 20, step 1)
the AirKast server recognizes the area code the user originating the SMS text message was sent from.
the AirKast server sends back to the user via SMS text message a list of participating radio stations in the user's wireless device local area code; user then selects the radio station they want to monitor through a SMS text message sent back to the AirKast server (see FIG. 20, step 2)
after the user selects the radio station they want to monitor, he/she is given (2) options:
   one option is the AirKast server receives the user's selection of the radio station they want to monitor and the current song being broadcasted is tagged; confirmation is then sent back to the user via SMS text message song was successfully tagged (see FIG. 20, step 3(A))
second option is the AirKast server sends back a SMS text message to the user with the list of the last 3-10 songs broadcasted by the radio station he/she has selected; user selects which song he/she would like to tag and the instruction is sent to the AirKast server via SMS text message; confirmation is then sent back to the user via SMS text message song was successfully tagged (see FIG. 20, step 3(B))
when the instruction from the wireless device to tag a song is received by the AirKast server, the following information is generated by the AirKast server into the user's web account: details of the tagged song such as song title, artist, album song was from, other albums and music from the artist, album cover art work, artist bio, and artist concert information including registering for email alerts to notify users when event tickets go on sale.
once the tagging process is completed by the wireless device and AirKast server, a return SMS text message confirmation is sent to the user indicating the selected song/artist was successfully tagged (see FIG. 20, step 3(A))

Music Tagging via Interactive Voice Response System (IVR System)

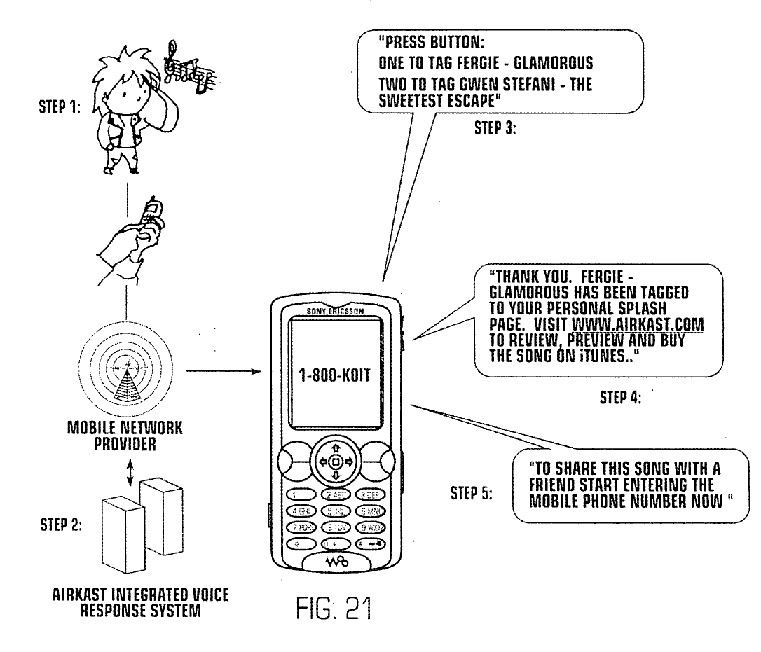

Method (C-1) Calling a Specific Radio Station Telephone Number
user listens to a broadcasted song on the radio and desires to tag the song for later purchase; he/she calls a designated radio station telephone number (or telephone number designated by AirKast) (see FIG. 21, step 1)
the call is routed to the AirKast IVR System which receives the call and announces songs currently and recently broadcasted that can be tagged by the user (see FIG. 21, steps 2-3)
user listens to the responses from the AirKast IVR System for the list of songs and artists currently and recently broadcasted by the radio station
user selects the song/artist they would like to tag through an IVR command (see FIG. 21, step 3)
the AirKast IVR System communicates with the AirKast server to process the request to tag songs and the following information is generated by the AirKast server into the user's web account: details of the tagged song such as song title, artist, and album song was from, other albums and music from the artist, album cover art work, artist bio, and artist concert information including registering for email alerts to notify users when event tickets go on sale.
the AirKast IVR System confirms that the song was successfully tagged (see FIG. 21, step 4)

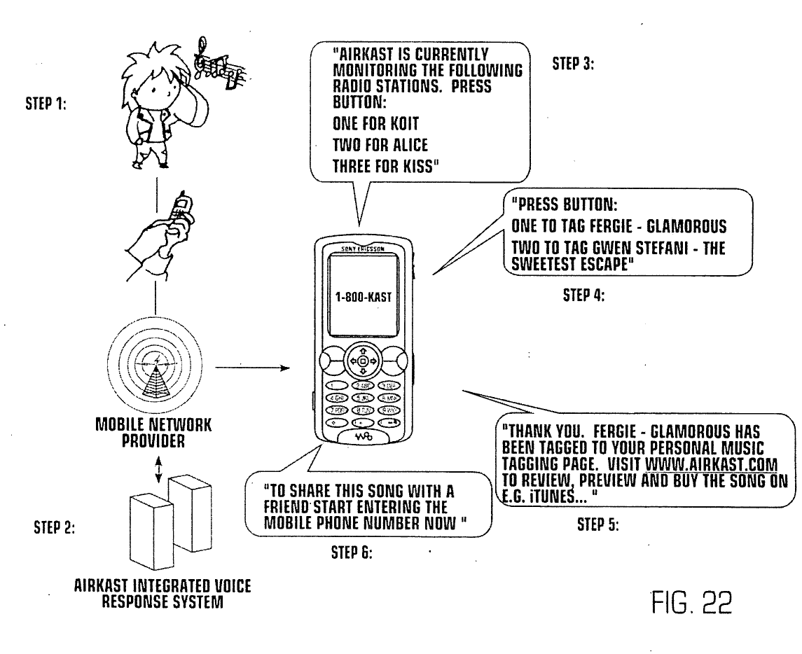

Method (C-2) Calling an AirKast Designated Telephone Number
user listens to a broadcasted song on the radio and desires to tag the song for later purchase; he/she calls a designated AirKast telephone number (see FIG. 22, step 1)
the call is routed to the AirKast IVR System which receives the call and processes the user's request (see FIG. 22, step 2)
the AirKast servers and IVR System recognizes the area code of the user's wireless device from the inbound call and announces the list of radio stations in the area code's local area that are participating in the AirKast Music Tagging System (see FIG. 22, step 3)
user selects a particular radio station and listens to the responses from the

AirKast IVR System for the list of songs and artists currently and recently broadcasted by the selected radio station (see FIG. 22, step 4)
user selects the song/artist they would like to tag through an IVR command
the AirKast IVR System communicates with the AirKast server to process the request to tag the song and the following information is generated by the AirKast server into the user's web account: details of the tagged song such as song title, artist, and album song was from, other albums and music from the artist, album cover art work, artist bio, and artist concert information including registering for email alerts to notify users when event tickets go on sale.
the AirKast IVR System confirms that the song was successfully tagged (see FIG. 22, step 5)

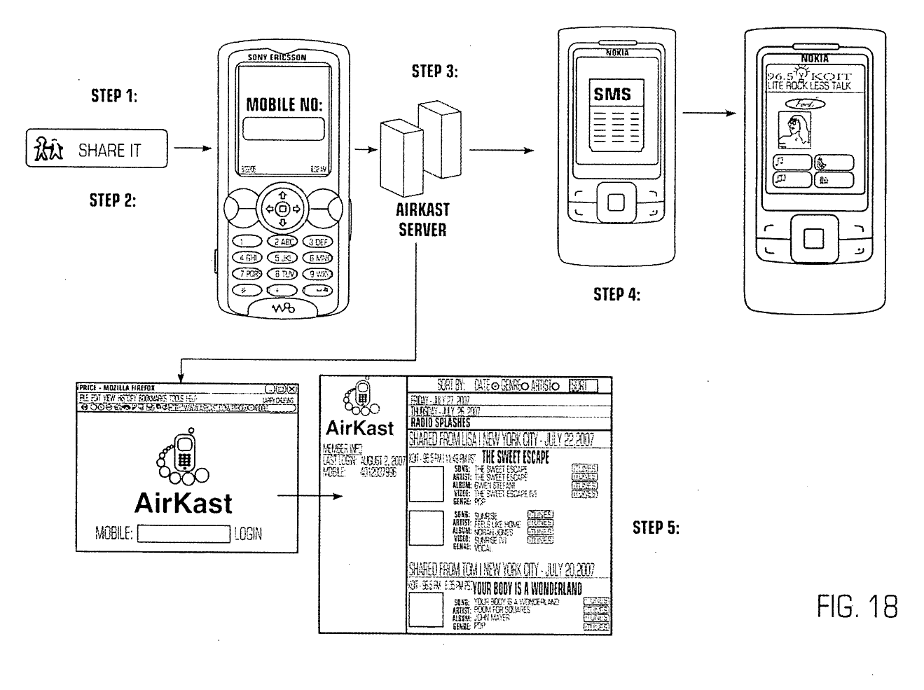

Sharing Tagged Music via Internet Browser Enabled Cell Phone
user #1 is viewing lyrics from a broadcasted song from a radio station participating in the AirKast Music Tagging System and wants to share the song with a friend or family member (user #2)
by having user #1 engage the “Share It” feature and entering the wireless device phone number of user #2, the request is processed by the AirKast server and a link with the song title/artist name/lyrics is generated and sent via SMS text message to user #2 (see FIG. 18, steps 2-3)
user #2 receives a SMS text message from the AirKast server noting user #1 has sent them a tagged song he/she would like to share, accompanied with a link to click-through in the event user #2 has an internet browser enabled wireless device
if user #2 has an internet enabled browser on their wireless device, clicking-through on the link in the SMS text message will enable him/her to view the lyrics to the song and tag it at a later time to conduct additional online music purchasing options; the AirKast server creates a new web account for user #2 if one does not exist already (see FIG. 18, steps 4-5)
if user #2 only has SMS text messaging capability on his/her wireless device, he/she has the ability to tag the shared song by sending a request in the reply of the SMS text message sent from the AirKast server; once the AirKast server receives the request to tag the song, a new web account is created under user #2's wireless device phone number which is automatically logged when user #2 sent the SMS text message to the AirKast server
when user #2 initiates to tag the shared song, the AirKast server generates the following information into user #2's web account: details of the shared song such as song title, artist, album song was from, other albums and music from the artist, album cover art work, artist bio, and artist concert information including registering for email alerts to notify users when event tickets go on sale
once the tagging process is completed by the AirKast server, a confirmation is sent to user #2 via SMS text message indicating the selected song/artist was successfully tagged

Sharing Tagged Music via SMS Text Messaging
user #1 tags a song and receives a SMS text message confirmation from the AirKast server that the song was successfully tagged
if user #1 has SMS text messaging capability on his/her wireless device, he/she can share a tagged song with a friend or family member (user #2) by replying to the SMS text message confirmation with user #2's wireless device phone number; the request from user #1 is sent to the AirKast server via SMS text message, processed and a message is generated and sent via SMS text message to user #2 (see FIG. 19, step 4)
user #2 receives a SMS text message from the AirKast server noting user #1 has sent them a tagged song he/she would like to share, accompanied with a link as a convenience for internet browser enabled wireless devices
if user #2 has an internet enabled browser on their wireless device, they can view the lyrics to the song, tag the song, and conduct additional online music purchasing options
if user #2 has SMS text messaging capability on his/her wireless device, he/she has the ability to tag the shared song by sending a request in the reply of the SMS text message sent from the AirKast server; once the AirKast server receives the request to tag the song, a new web account is created under user #2's wireless device phone number which is automatically logged when user #2 sent the reply SMS text message
when user #2 initiates to tag the shared song, the AirKast server generates the following information into user #2's web account: details of the shared song such as song title, artist, album song was from, other albums and music from the artist, album cover art work, artist bio, and artist concert information including registering for email alerts to notify users when event tickets go on sale
once the tagging process is completed by the AirKast server, a confirmation is sent to user #2 via SMS text message indicating the selected song/artist was successfully tagged

Sharing Tagged Music via AirKast Interactive Voice Response System (IVR System)
user #1 calls a designated telephone number and selects option for sharing tagged music through the AirKast IVR System
user #1 is prompted to enter the wireless device phone number of the friend or family member (user #2) he/she would like to share the tagged song with and the AirKast server generates a SMS text message to the friend or family member inviting them to tag and listen to the song shared from user #1 (see FIG. 21, step 5)
user #2 receives a call from the AirKast IVR System or/or receives a SMS text message from the AirKast server noting a user with user #1's wireless device phone number has sent them a tagged song he/she would like to share
if user #2 desires to tag the song shared from user #1 through the AirKast IVR System, he/she will be enter the appropriate prompt and the AirKast IVR System communicates with the AirKast server to process the request and the following information is generated by the AirKast server into user #2's web account: details of the tagged song such as song title, artist, album song was from, other albums and music from the artist, album cover art work, artist bio, and artist concert information including registering for email alerts to notify users when event tickets go on sale
the AirKast IVR System confirms to user #2 the song was successfully tagged.
alternatively, user #2 will have the option tag the song through either the “music tagging process on an internet browser enabled wireless device” or the “music tagging process via SMS text messaging” as described previously

Sharing Tagged Music via Social Networking Sites
user #1, while online with his/her AirKast web account, selects the appropriate share feature of all tagged songs, albums, and music videos to be posted to desired members of all supported social networking sites such as MySpace and Face Book
members of social networking sites will be able to view all entries user #1 has elected to share including tagged songs, albums and music videos
members of social networking sites viewing shared tagged songs, albums and music videos will have the ability to conduct a variety of online music purchase transactions directly from the links that are generated by the AirKast servers as part of the posting of tagged music

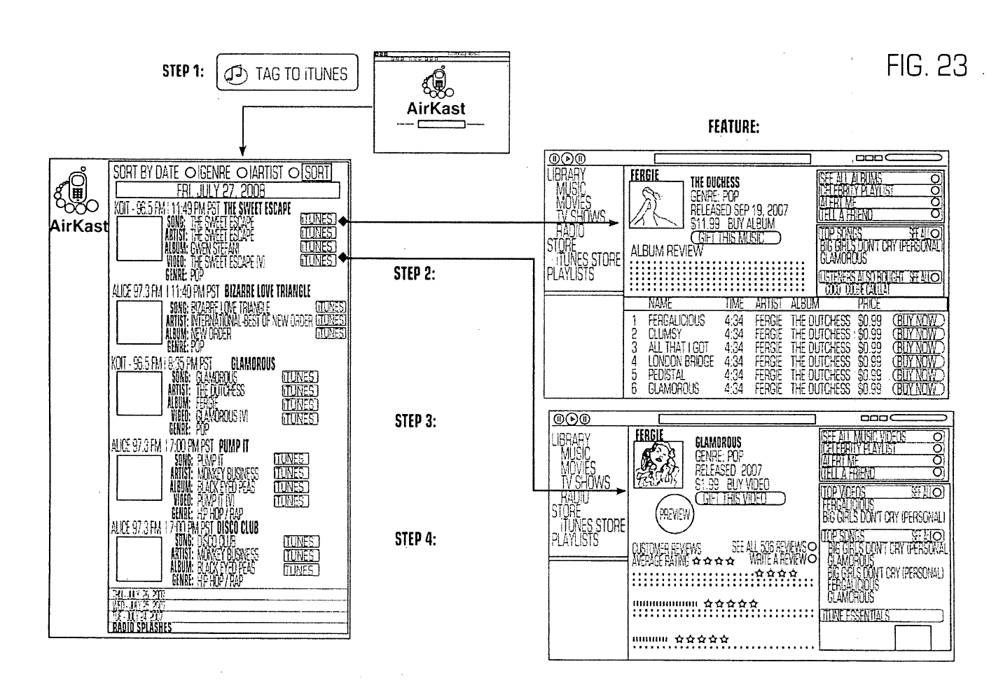

Web Account
through an AirKast designated URL, user initiates access to his/her web based account, with identity authentication provided by entering his/her wireless device phone number and email or another established identity authentication process
user has ability to conduct a variety of online music preview and purchase transactions of all tagged songs, albums that contains the tagged songs, other albums from the same artist, music videos from the artist, concert information performed by artist including registering for email alerts to notify users when event tickets go on sale (see FIG. 23, steps 2-4)
users that tag a particular song can select from various popular hits lists in same song genre, or simply enter the names/artist of songs they highly recommend for sharing with all web account users
when user previews information for a tagged song, he/she will also see a list of other songs that are recommended or issued a high satisfaction rating from other users that tagged the same original song
user can also conduct online music purchase in the web account through the history of all tagged music “sorted by date, by genre or music shared from other friends folder” (see FIG. 23 “Feature” note)
online music purchase is conducted in similar graphical user interface “buttons” to provide user familiarity with completing the online purchase transaction directly with the online music provider of their choice or alternatively, directly with the shopping cart, check out, and purchase confirmation supported by the AirKast server
once online music purchase is initiated from the AirKast web account, purchase transaction is completed within the selected online music provider's web-based application for shopping cart, check-out and purchase confirmation process
user has the ability to engage the “Share It” feature for tagged music with other users through SMS text messaging, internet browser enabled wireless device, AirKast IVR System and AirKast web account posting to social networking sites

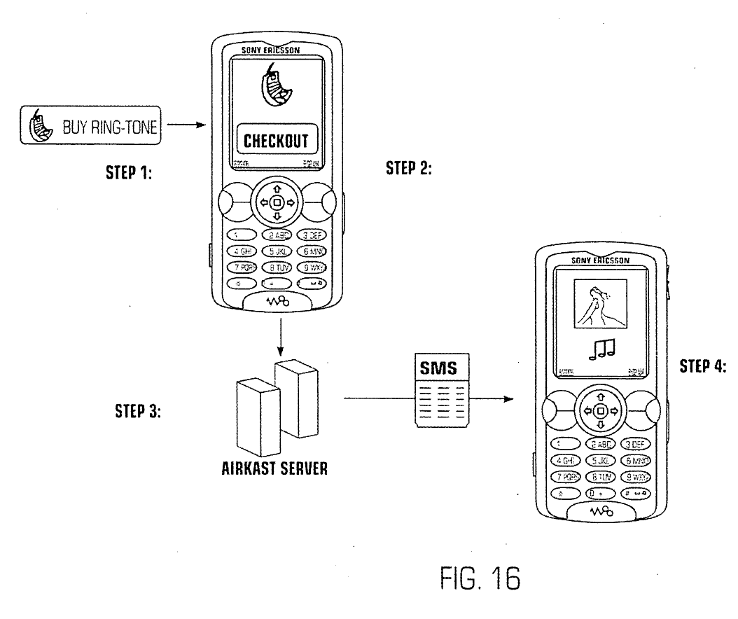

Ringtones
user has the ability from the wireless device to select the “Buy Ringtone” feature of available ringtone(s) for the corresponding song(s) through an internet browser enabled wireless device
from a SMS text messaging enabled wireless device, user is able to purchase available ringtone(s) for tagged songs through a sequenced reply to the SMS text message sent from the AirKast server with the tagged song information
for both internet browser and SMS text messaging enabled wireless devices, the AirKast server routes the ringtone purchase request to the ringtone provider to complete the purchase and download process of the ringtone(s) (see FIG. 16)

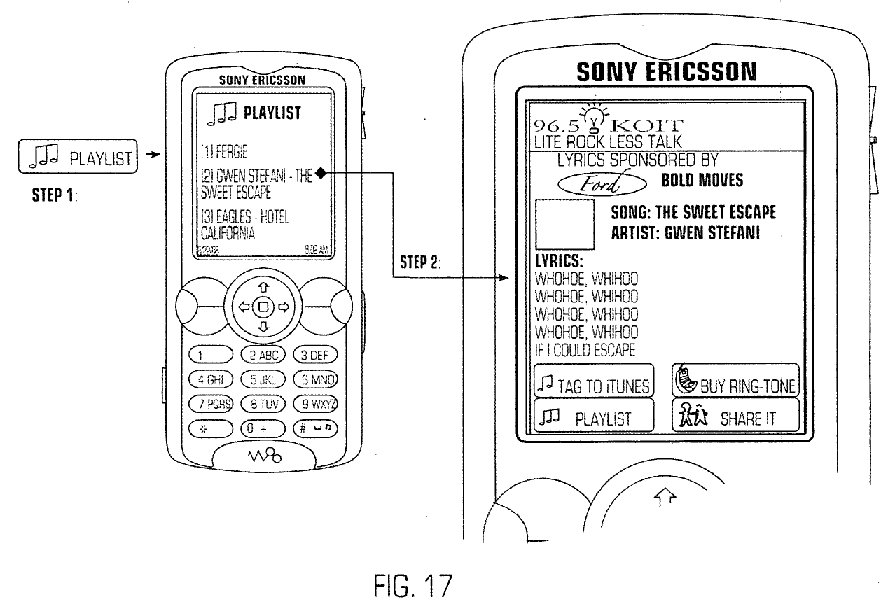

Playlist
from a user's internet browser enabled wireless device, he/she selects the “Playlist” feature and reviews the list of previously broadcasted songs from the radio station being monitored; user is then able to view the lyrics on his/her wireless device for any of the selected songs and listen to a 30 seconds or less clip of the song (see FIG. 17)
users with SMS text message or voice only capability will also have the ability to review the list of previously broadcasted songs from the radio station being monitored and then select any of the songs for tagging
all songs on the user's “Playlist” or archive of tagged songs can be purchased through an online music provider, have ringtones purchases for the corresponding songs or shared with friends and family to help expand their respective “Playlists”

Artist “Info” Feature
a user of wireless devices will have the ability to access the “Info” feature where he/she can retrieve the latest information, updates, music tour progress for the artist whose song is being broadcasted by the participating radio station
the “Info” feature will also offer the ability to complete purchase of promotional and merchandising items through tagging the product and completing the purchase online later
concert and event tickets can also be viewed with the “Info” feature; a user can review which dates, times and price categories meet his/her needs and can tag the selected event to purchase online through a computing device

Instant Community Ratings
several users which may be friends or family members listening to the same participating radio station will be able to easily form a virtual community and see what satisfaction rating each member submits for the current broadcasted song
users will be able to send invitations to ask other users to join their virtual community by entering the invitee's mobile number through the wireless device or going online to the web account
invitees decide whether they want to accept and be a part of the select virtual community to share instant song rating information with other members
as the organizer of the select virtual community engages the feature on his/her wireless device to conduct “instant community ratings”, members of the virtual community listen to the same song from the same participating radio station; they are then able to enter on their wireless device the satisfaction rating for the current broadcasted song; all members of the select virtual community will receive a SMS text message with a record of each member's ratings until all members have submitted their rating

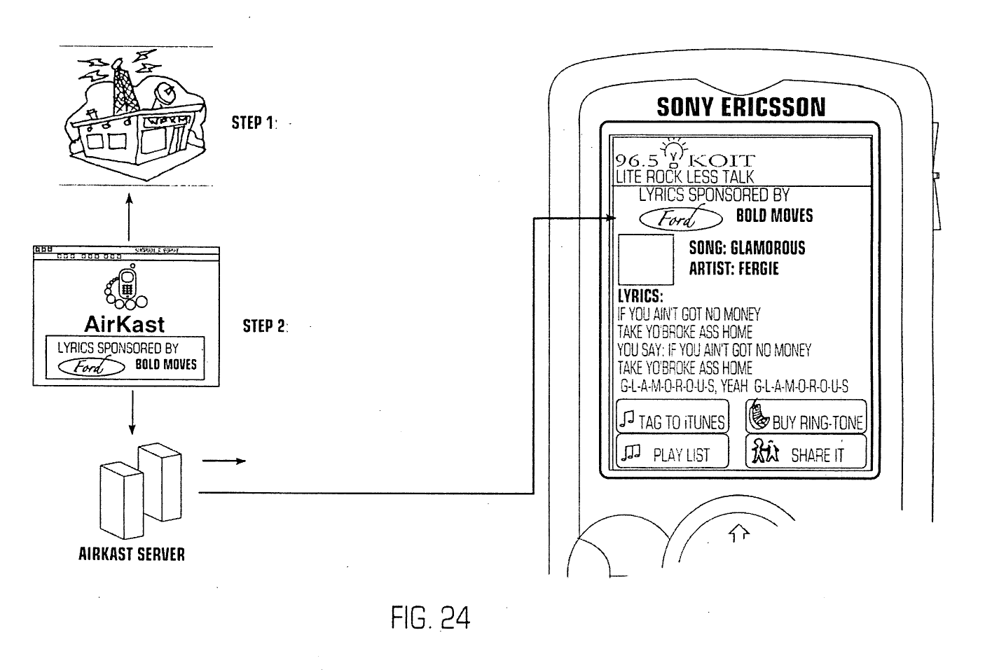

Radio Broadcasters Configurator
through the Radio Broadcasters Configurator application, participating broadcast radio stations can configure the song lyrics and visual advertising for internet browser enabled wireless devices simultaneous or near simultaneous with radio broadcasting of songs and audio advertising; with SMS text message enabled and voice only wireless devices, the Configurator application will also be able to configure visual and audio based sponsored advertisements, respectively
for users with internet browser enabled wireless devices, configuration requests for advertisements and sponsorship messages for participating radio stations can be dynamically made “on-the fly” with the Configurator application and processed by the AirKast server for publication and distribution to users' wireless devices
advertising messages displayed on wireless devices can be configured to be rules based with date, time, duration of time and other criteria (see FIG. 24, steps 1-2)

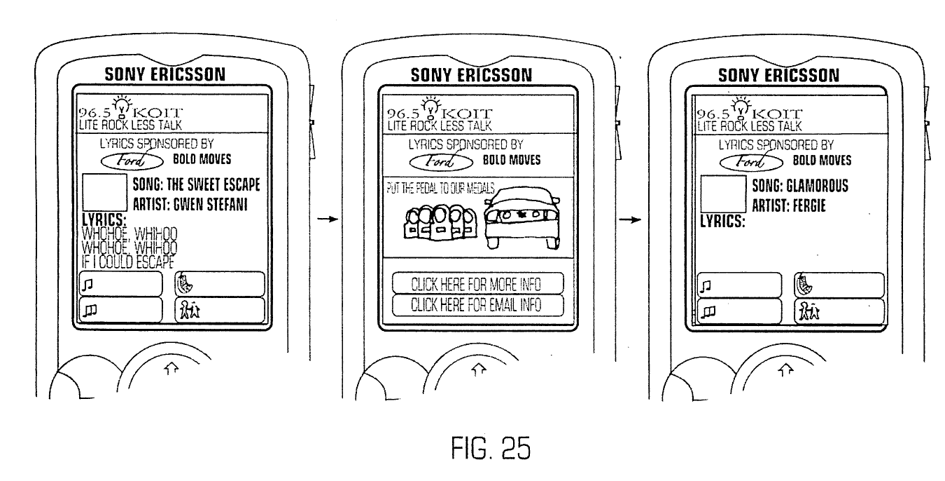

Visualization of Live Radio
advertisements through internet browser enabled wireless devices, published and displayed simultaneously or near simultaneously to broadcast radio audio advertisements can be HTML enabled allowing users to “click-through” to advertisers to obtain more information or immediately engage with them in a particular promotion or offering (see FIG. 25)
advertisements and sponsorship messages for SMS text message and voice only wireless devices will also be able to see visual based and audio based sponsored advertisements, respectively
pre-planned visual display advertisements for listeners' wireless devices can be automatically scheduled and published during times slotted for each advertisement or sponsorship message; when music is broadcasted again, internet browser enabled wireless devices are able to view the lyrics for the corresponding song being broadcasted and view graphical and pictorial advertisements slotted for publishing (see FIG. 25)

Price Search and Comparison

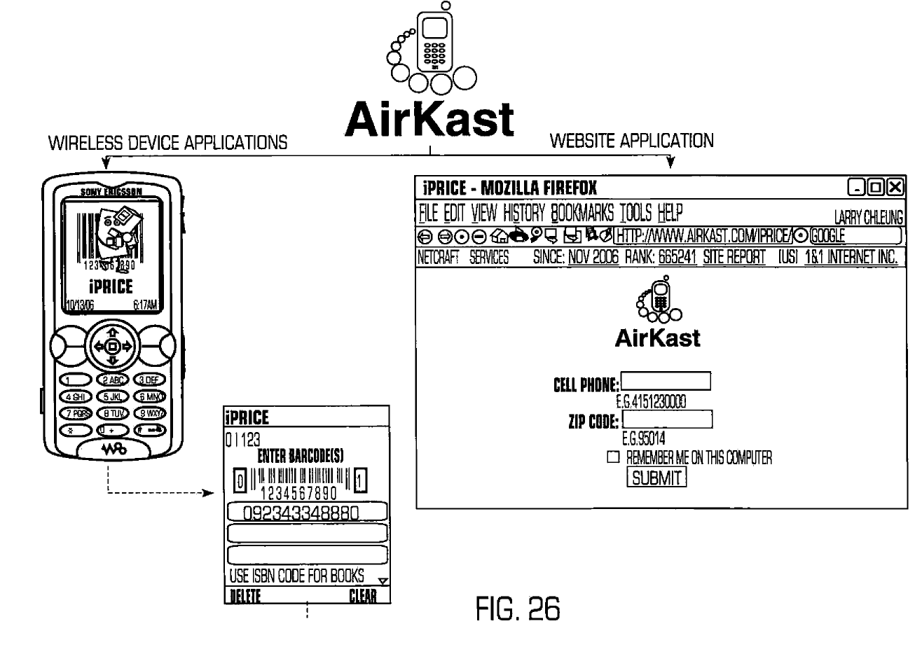

FIG. 26 illustrates another embodiment of the wireless tagging system and method that provides comparison pricing and tag a product for future reference through a wireless device for millions of products identified with a UPC (uniform product code) or ISBN (international standard book number) code using SMS text messaging and internet browser access. Currently, price comparison shopping is predominately conducted through an online computing device. The invention would give a user true portability and convenience by enabling them to conduct a price search and tag the product on their wireless device, and then be able to purchase all the tagged products when he/she obtains access again to their online computing device. This provides invaluable price knowledge information anytime and almost anywhere, enabling the user to make an informed decision if they should complete a purchase at a brick and mortar store they're physically shopping at now or if they can realize significant savings by completing the purchase through a number of convenient purchase options the invention has created.

The system and method are comprised of custom developed software application and algorithms for wireless devices, computing devices and file servers. The wireless device application facilitates the easy entry of a UPC code or ISBN product code into a wireless device, sends the price request through a SMS text message to the invention's content discovery engine and requests the lowest prices from a single Comparison Shopping Engine or multiple Comparison Shopping Engines on the internet, depending on the user's preferences. The price search request is then sent to the AirKast broadcast engine where it is forwarded to a carrier's SMS server which then delivers the specially encoded SMS text message for display onto the user's wireless device. Simultaneously, the products being initiated for price searches by the wireless device are tagged by the invention and automatically placed it into the user's email and his/her web account accessed through the company's designated website.

For wireless devices that have internet browser access, the invention enables the execution of HTML links which supports a user's ability to view product descriptions, pictures and information about vendors offering the interested product. In addition, users will have the option to complete from their wireless device select consumer purchasing transactions, viewing of maps to stores, driving directions to stores, promotions, coupons, information and critiques of products, merchants, businesses and service providers within a range of predefined proximities to a specific zip code.

The computing device will be able to display price comparisons through two primary processes. One process is through the user's email account, where a list of all price comparisons and the corresponding links from the merchants with the lowest prices can be viewed and “clicked-through”. The second process is through the user's online web account, again where all price comparisons and corresponding links can be viewed and “clicked-through”. The web account will have more sorting capabilities that will make it more attractive and useful to search on previous price search requests. Through the web account, users will also be able to conduct reverse auctions to facilitate an ability to have merchants come forward and sell interested products at prices set by the user.

Obtaining Mobile Price Search Application

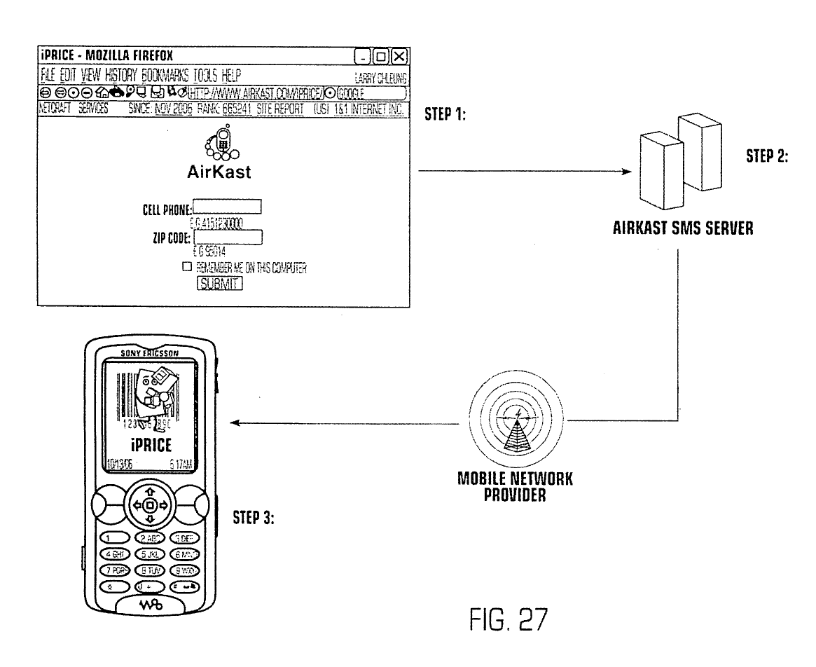

Method (A)—From AirKast Website
user wants to receive a copy of the AirKast Price Search application on his/her wireless device
user logs onto AirKast Price Search website and enters their wireless device phone number, zip code, and model of wireless device and information is sent to AirKast's SMS server (see FIG. 27, step 1)
AirKast's SMS server creates a SMS text message with a URL specifically for the wireless device model indicated in the request on the AirKast Price Search website. The SMS text message is then sent back to the user's cell phone through their wireless carrier (see FIG. 27, step 2)
user receives the SMS text message and then clicks on the URL in order initiate and automatically complete the download and installation of the Price Search application (see FIG. 27, step 3)

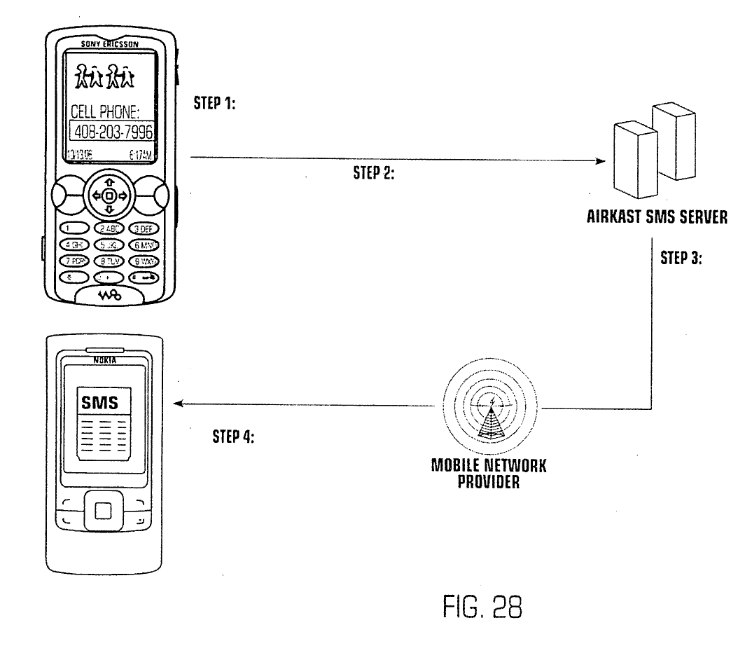

Method (B)—“Pass It On”—Mobile-Mobile
if user #1 already has the AirKast Price Search application installed, he/she can choose to initiate a copy of the application to be sent to user #2's wireless device
user #1 which already has the AirKast Price Search application installed selects on the menu options “Pass It On”, the name assigned to the feature to initiate sending a copy of the application to another user, or in this illustration, user #2 (see FIG. 28, step 1)
user #1 selects from a list of models of wireless devices the model that matches user #2's wireless device, includes user #2's wireless device phone number and sends the information via SMS text message to AirKast's SMS server
AirKast's SMS server creates a SMS text message with a URL specific to user #2's wireless device model indicated in the request from user #1. The SMS text message is then sent back to user #2's wireless device through his/her wireless carrier (see FIG. 28, step 3)
user #2 receives the SMS text message and then clicks on the URL in order initiate and automatically complete the download and installation of the Price Search application (see FIG. 28, step 4)

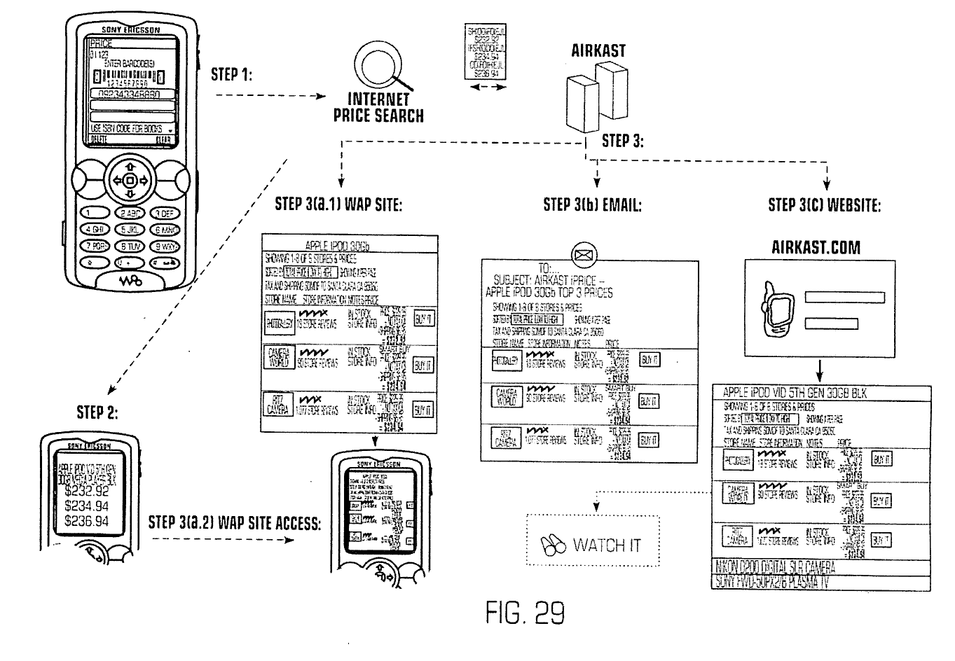

Performing Price Search from Mobile Device
user identifies a product code for a product he/she is interested in receiving a price comparison
user launches AirKast “Price Search” application on wireless device
user enters ISBN numbers for books and UPC numbers for products they want to conduct price search and tag, following the graphics allowing for exact number of digits required to be entered (see FIG. 29, step 1)
information from user is sent via SMS text message to the AirKast servers
AirKast servers retrieve the (3) best prices from the user's pre-selected list of internet Comparison Shopping Engines and merchants, and then sends the price comparison information back to the user via SMS text message (see FIG. 29, step 2)

Merchant “Click-Through” Methods
there are (3) methods for users to receive HTML links from merchants to “click-through” to view and purchase products:

1. AirKast generates a WAP site formatted for access from the user's wireless device

2. all tagged products from the wireless device are simultaneously sent to the user's email inbox

3. a history of all tagged products from the wireless device is available through accessing the web account through the company's designated website

Method (1) WAP site:
within the SMS text message sent back to the user's wireless device, users views the price comparisons and have the option to click on the WAP site link
with an internet browser enabled wireless device, user clicks on the WAP site link to view display of merchant's logos and corresponding prices generated by the WAP site (see FIG. 29, step 3(a.2))
provided adequate bandwidth is available for the internet enabled wireless device, users will be able to “click-through” to view pictures of products tagged, review other shipping options, and complete purchase of the product

Method (2) Email:
user logs onto email account and views all price searches initiated from user's wireless device (see FIG. 29, step 3(b))
user opens emails for tagged products interested in purchasing
user “clicks-through” the merchant links for additional information and to complete purchase

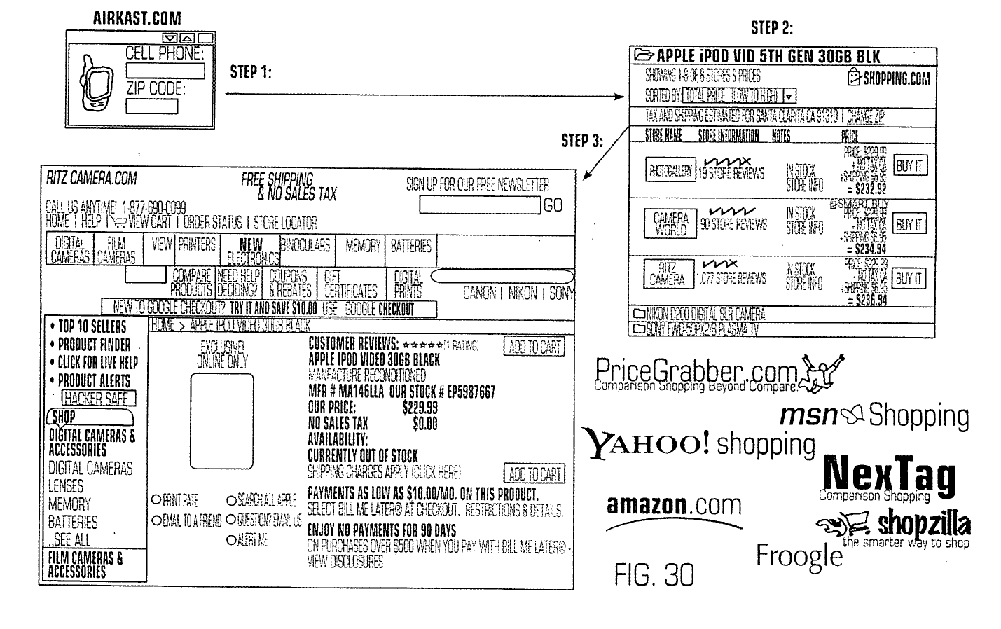

Method (3) Web Account:
when users initially register their wireless device phone number and zip code on the AirKast Price Search application, a web account is also created for the user (see FIG. 30, step 1 and FIG. 29, step 3(c))
user logs onto web account with their wireless device phone number and zip code; they view all price searches initiated from the user's wireless device, sorted by date and other product classifications (see FIG. 30, step 2)
user “clicks-through” the merchant links for products he/she is interested to obtain additional information and to complete purchase (see FIG. 30, step 3)

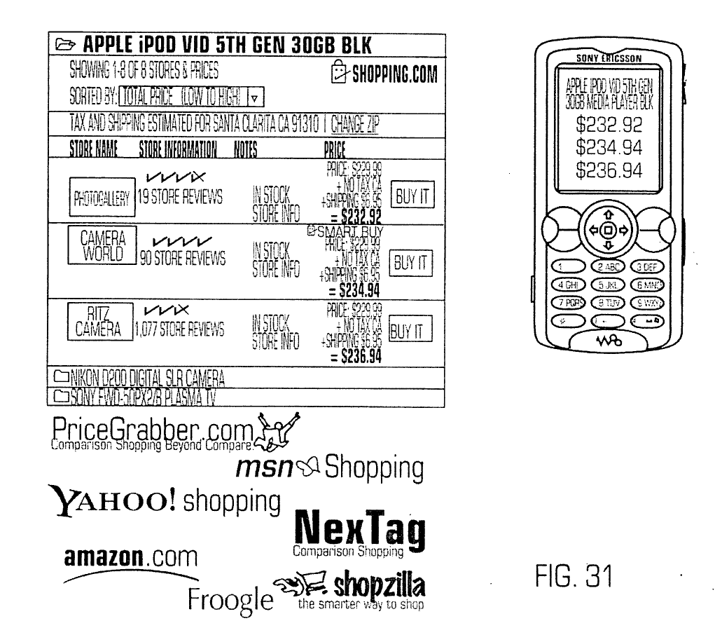

Price Comparison Results
the price search is processed by AirKast's servers and its sources of prices, availability and product description are provided by Comparison Shopping Engines, merchants and stores (see FIG. 31)
AirKast sends the price search information to the user's wireless device via a SMS text message, displaying the (3) lowest prices available from the user's pre-selected list of Comparison Shopping Engines, merchants and stores (see FIG. 31)

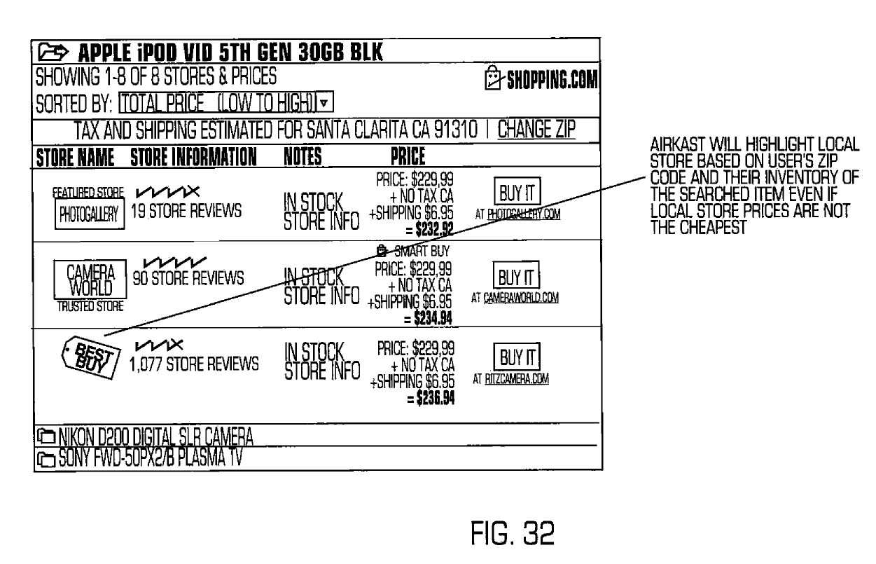

Location Based Product Availability
price search results will show local merchants selling tagged products based on user's zip code when user selects the location based product availability option (see FIG. 32)
local merchant inventories will display their inventory levels even if they are not the lowest price merchant, provided the user has selected the location based product availability option

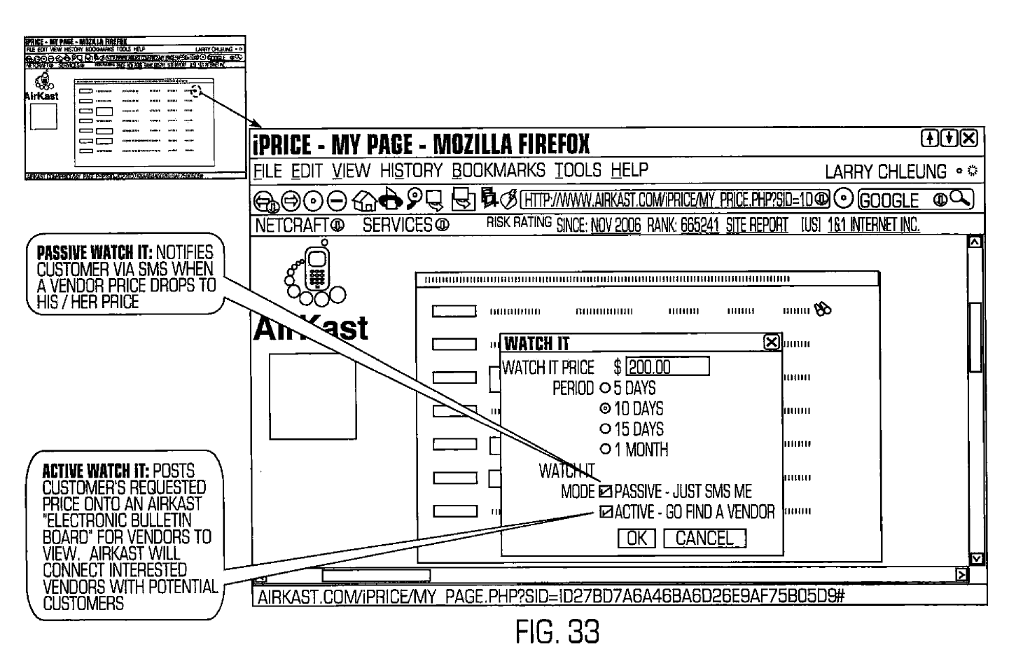

Reverse Auction Capabilities (Watch It)
through both the “Passive Watch It” and “Active Watch It” reverse auction features, users will be notified and able to complete a purchase transaction when a merchant agrees to complete the sale of the user's identified product at the user's desired price within the time frame specified by the user
through the AirKast Price Search web client, users will be able to enter prices they wish to pay for identified products through (2) methods (see FIG. 33):

1. Passive Watch It

2. Active Watch It

(1) Passive Watch It: through the user's tagged products in his/her web account, the “Passive Watch It” feature is selected and the following information is entered: desired price and the time period he/she would agree to complete purchase for if both conditions are met
AirKast servers subscribe to RSS (Really Simple Syndication) feeds from Comparison Shopping Engines and other merchants to monitor the identified product and current lowest selling price available until the current selling price falls to the point where it matches the user's desired purchase price
if the current lowest selling price available matches the user's desired purchase price within the time frame noted in the feature, the merchant notifies the user through a SMS text message confirming the pending sale with the appropriate links for the user to “click-through” to complete the purchase on the web account

(2) Active Watch It: through the user's tagged products in his/her web account, the “Active Watch It” feature is selected and the following information is entered: desired price and the time period he/she would agree to complete purchase for if both conditions are met
the product code, product description, the user's desired price and purchase time period are posted onto an AirKast “electronic bulletin board” for merchants to actively view
if a merchant agrees to sell the identified product at the user's desired price, the merchant will be required to send an electronic confirmation to AirKast to end the reverse auction for the particular user for the identified product; after confirmation the merchant communicates with the user through a SMS text message notifying the user the particular merchant has agreed to meet their price for the identified product and purchase is completed by “clicking-through” the appropriate links sent to their web account

While the foregoing has been with reference to a particular embodiment of the invention, it will be appreciated by those skilled in the art that changes in this embodiment may be made without departing from the principles and spirit of the invention, the scope of which is defined by the appended claims.

1. A tagging system, comprising:
a computer implemented platform;
one or more wireless devices that are capable of communicating with the computer implemented tagging unit over a link, each wireless device further comprising a tag module; and
the computer implemented platform further comprising a tagging unit that enables, in conjunction with the tag module, each of the one or more wireless devices to tag an item indicating an interest in the item.

2. The system of claim 1, wherein the item is one of a product and a service.

3. The system of claim 2, wherein the product is music.

4. The system of claim 1, wherein each of the one or more wireless devices further comprises a purchase module wherein the wireless device retrieves a tagged item and completes purchase of the item using the purchase module.

5. The system of claim 1 further comprising a computing device that is capable of communicating with the computer implemented platform that retrieves a tagged item and completes purchase of the item.

6. The system of claim 1, wherein the computer implemented platform further comprises an advertising provision manager that presents advertisements to the one or more wireless devices.

7. The system of claim 6, wherein the advertisements further comprise one of a splash advertisement, a full page advertisement and a media advertisement.

8. The system of claim 6, wherein the item further comprises an advertisement displayed on the wireless device.

9. The system of claim 6, wherein the advertising provision manager presents advertisements to a particular wireless devices based on the location of the particular wireless device.

10. The system of claim 1, wherein each wireless device further comprises a graphics wall module that displays a graphical wall on the wireless device representing one or more pieces of time shifted content.

11. The system of claim 1, wherein each wireless device further comprises a sharing module that permits tagged items to be shared with other wireless devices.

12. The system of claim 1, wherein the computer implemented platform further comprises a vote manager that manages votes from wireless devices.

13. The system of claim 1, wherein the computer implemented platform further comprises a content upload module for uploading content into the system.

14. The system of claim 1, wherein the computer implemented platform further comprises a synchronization manager that provides real-time synchronization of the tagging with live broadcast media.

15. The system of claim 1, wherein each wireless device displays one or more tagged items and variations of the featured items.

16. The system of claim 1, wherein each of the one or more wireless devices further comprises a purchase module wherein the purchase module is capable of purchasing items based on a live broadcast media.
